(19) United States
(12) Patent Application Publication
(10) Pub. No.: US 2005/0287452 A1
(43) Pub. Date: Dec. 29, 2005

(54) Photoconductor, image forming process, image forming apparatus, and process cartridge

(76) Inventors: Hiroshi Tamura, Susono-shi (JP); Hiroshi Ikuno, Yokohama-shi (JP); Yoshiki Yanagawa, Numazu-shi (JP); Tetsuro Suzuki, Fuji-shi (JP); Yoshiaki Kawasaki, Susono-shi (JP); Naohiro Toda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/157,998

(22) Filed: Jun. 22, 2005

(30) Foreign Application Priority Data
Jun. 24, 2004 (JP) 2004-186676

(51) Int. Cl. G03G 5/047

(52) U.S. Cl. 430/58.7; 430/56; 430/58.05; 430/124; 399/159

(57) ABSTRACT

A photoconductor is disclosed that exhibits superior wear resistance, excellent flaw resistance, and appropriate electric properties owing to a photosensitive layer having a crosslinked layer with superior smoothness and higher crosslink density, wherein the photoconductor comprises a support, and a photosensitive layer disposed on the support, the photosensitive layer comprises a crosslinked layer, the crosslinked layer comprises a radical polymerizable monomer having three or more functionalities and no charge transport structure and a radical polymerizable compound having one functionality and a charge transport structure, and the crosslinked layer is cured by way of photopolymerization and thermal polymerization.

### BACKGROUND OF THE INVENTION

1. Field of the Invention

The present invention relates to photoconductors that can provide higher image quality for prolonged period, owing to photosensitive layers that can exhibit superior wear resistance, excellent flaw resistance, and appropriate electric properties; and image forming processes, image forming apparatuses, and process cartridges that utilize the photoconductors respectively.

2. Description of the Related Art

Recently, organic photoconductors (OPC) are widely employed in copiers, facsimiles, laser printers, and composite apparatuses thereof owing to excellent performance and various advantages, in place of conventional inorganic photoconductors. Specific grounds thereof are thought as follows: (i) optical properties such as absorbable wavelength and absorption rate, (ii) electrical properties such as higher sensitivity and stable charging ability, (iii) margins of materials, (iv) productivity, (v) lower cost, (vi) safety, and the like.

On the other hand, photoconductors have been small-sized along with image forming apparatuses being small-sized; in addition, higher processing rate as well as maintenance free are have been required for image forming apparatuses; consequently, photoconductors are demanded for higher durability still more nowadays.

However, organic photoconductors are typically less durable since the hardness of the surface layers is relatively low due to their inherent components of charge transport substances of lower molecular mass and inactive polymers; therefore, the surface layers tend to wear significantly due to mechanical stress caused by developing systems and cleaning systems etc. under repeated usages in electrophotographic processes.

Further, rubber hardness of cleaning blades has been raised and pressure onto photoconductors applied from the cleaning blades has been increased so as to improve cleaning ability in order to enhance image quality by using toner particles with smaller particle sizes, which inevitably leading to higher wear rate of photoconductors. The wear of photoconductors certainly degrades sensitivity, electric properties such as charging ability etc., which resulting in deteriorated images such as lower image density and background smear. Further, flaws due to local wear often bring about streak on images due to insufficient cleaning. Such wear and flaws typically dominate photoconductors in terms of lifetime to be exchanged, currently.

As such, the wear rate should be decreased in order to enhance durability of organic photoconductors, which is one of the most important objects in the art.

Previously, various proposals have been provided in order to enhance wear resistance of photosensitive layers, for example, (i) incorporation of curable binders into the photosensitive layer (e.g. Japanese Patent Application Laid-Open (JP-A) No. 56-48637), (ii) employment of polymers for charge transport substances (e.g. JP-A No. 64-1728), (iii) dispersing inorganic fillers into surface layers (e.g. JP-A No. 4-281461), and the like.

However, in the (i) incorporation of curable binders described above, residual voltage tends to increase owing to impurities such as polymerization initiators and/or unreacted residual groups due to insufficient compatibility with charge transport substances, thus image density tents to decrease; in the (ii) employment of polymers for charge transport substances described above, the durability cannot be sufficiently improved for satisfying the requirements for organic photoconductors; moreover, electric properties of organic photoconductors are likely to be unstable since polymers for charge transport substances are difficult to be polymerized and purified, and also coating liquids of them are typically excessively viscous to be processed.

The inorganic fillers dispersed in inactive polymers (iii) described above may exhibit higher wear resistance, compared to that of conventional photoconductors comprising charge transport substances having a lower molecular mass. However, traps on the surface of the inorganic fillers tend to increase residual potential, thereby causing decrease in the image density. Also, when unevenness of the photoconductor surface is significant due to the inorganic filler and the binder resin, cleaning may be insufficient, resulting in toner filming and image deletion.

As such, based on these proposals (i), (ii), and (iii), the durability of organic photoconductors is not satisfactory on the whole, including electrical durability and mechanical durability.

Further, photoconductors containing cured product of a multi-functional acrylate monomer are proposed in order to improve the abrasion resistance and scratch resistance such as of (i) (e.g. Japanese Patent No. 3262488). In the patent literature, it is disclosed that cured material of the multi-functional acrylate monomer is included into a protective layer on photosensitive layers. However, there exist no more than simple descriptions that a charge transport substance may be contained in the protective layer and there exist no specific examples. Further, when a charge transport substance having a low molecular mass is simply added to the surface layer, it may cause problems related with the compatibility to the cured body, thereby crystallization of charge transport substance having a lower molecular mass and clouding may occur, resulting in reduction in mechanical properties.

In addition, a photoconductor is produced by way of causing reaction of monomers in a condition that a polymer binder is incorporated; therefore, there will be some problems that the curing cannot sufficiently proceed, and surface nonuniformity is induced due to phase separation at curing caused by insufficient compatibility between the cured material and the binder resin, which resulting in inferior cleaning in image forming apparatuses.

Further, another proposal is disclosed for reducing abrasion wear of photosensitive layers, in which a charge transport layer is provided using a coating liquid that comprises a monomer having a carbon-carbon double bond, a charge transport substance having a carbon-carbon double bond, and a binder resin (e.g. Japanese Patent No. 3194392). The binder resin includes a binder reactive with the charge transport substance having a carbon-carbon double bond and another binder non-reactive with the charge transport substance without having the double bond. The photoconductor allegedly represents higher wear resistance as well as proper electrical properties. However, non-reactive resins as the binder resin tend to yield surface irregularity and thus inferior cleaning, since the non-reactive resins are typically non-compatible with reaction products between the monomer and the charge transport substance, thus phase separation is likely to occur.

Further, the patent literature discloses monomers having two functionalities as specific examples, which cannot bring about sufficient crosslinking density and satisfactory wear resistance due to the lower functionalities. Provided that reactive resins are employed as the binder resin, the bonding density and the crosslinking density are possibly not sufficiently high due to the lower functionalities of the monomer and the binder resin, thus electric properties and wear resistance will not be satisfactory.

Further, another proposal is disclosed, in which photosensitive layers comprise reaction products that are produced by curing hole transport compounds having two or more functional groups capable of undergoing chain polymerization in a molecule (e.g. JP-A No. 2000-66425). However, the photosensitive layer tends to cause higher internal stress and thus to yield higher surface roughness and cracks, since the bulky hole transport compound have two or more chain polymerizable functional groups.

As such, photoconductors that are provided with a photosensitive layer having a charge transport structure cannot provide sufficient properties in various aspects, currently.

### SUMMARY OF THE INVENTION

The object of the present invention is to provide photoconductors that can exhibit superior wear resistance, excellent flaw resistance, and appropriate electric properties, more specifically, proper cleaning ability, higher durability, and higher image quality owing to photosensitive layers having a crosslinked layer with superior smoothness and higher crosslink density; and image forming processes, image forming apparatuses, and process cartridges that utilize the photoconductors respectively.

The photoconductors according to the present invention comprises a support, and a photosensitive layer disposed on the support, wherein the photosensitive layer comprises a crosslinked layer, the crosslinked layer comprises a radical polymerizable monomer having three or more functionalities and no charge transport structure and a radical polymerizable compound having one functionality and a charge transport structure, and the crosslinked layer is cured by way of photopolymerization and thermal polymerization. The photoconductors according to the present invention can provide higher durability, thus images can be provided with higher quality for prolonged period.

The image forming processes according to the present invention comprise forming an electrostatic latent image on a photoconductor, developing the electrostatic latent image by means of a toner to form a visible image, transferring the visible image on a recording medium, and fixing the transferred image on the recording medium, wherein the photoconductor is one according to the present invention.

The image forming processes according to the present invention can provide images with higher quality for prolonged period.

The image forming apparatuses according to the present invention comprise a photoconductor, an electrostatic latent image forming unit configured to form an electrostatic latent image on the photoconductor, a developing unit configured to develop the electrostatic latent image by means of a toner to form a visible image, a transferring unit configured to transfer the visible image on a recording medium, and a fixing unit configured to fix the transferred image on the recording medium, wherein the photoconductor is one according to the present invention.

The image forming apparatuses according to the present invention can provide images with higher quality for prolonged period.

The process cartridges according to the present invention comprise the photoconductor according to the present invention, and at least one unit selected from the group consisting of charging unit, developing unit, transferring unit, cleaning unit, and discharging unit, and the process cartridge is mounted detachably to an image forming apparatus.

### BRIEF DESCRIPTION OF THE DRAWINGS

FIG. 1A schematically shows an exemplary single-layered photoconductor according to the present invention, in which the crosslinked layer occupies the photosensitive layer entirely.

FIG. 1B schematically shows an exemplary single-layered photoconductor according to the present invention, in which the crosslinked layer is the surface portion of the photosensitive layer.

FIG. 2A schematically shows an exemplary inventive photoconductor containing laminated layers, in which the crosslinked layer occupies the charge transport layer entirely.

FIG. 2B schematically shows an exemplary inventive photoconductor containing laminated layers, in which the crosslinked layer is the surface portion of the charge transport layer.

FIG. 3 schematically shows an exemplary image forming apparatus according to the present invention.

FIG. 4 schematically shows an exemplary process cartridge according to the present invention.

### DESCRIPTION OF THE PREFERRED EMBODIMENTS

(Photoconductor)

The photoconductor according to the present invention comprises a support, a photosensitive layer disposed on the support, and other optional layers depending on requirements.

The photosensitive layer comprises a crosslinked layer, the crosslinked layer comprises a radical polymerizable monomer that has three or more functionalities and no charge transport structure and a radical polymerizable compound that has one functionality and a charge transport structure, and the crosslinked layer is cured by way of photopolymerization and thermal polymerization.

Preferably, a photopolymerization initiator and a thermal polymerization initiator are utilized in order to cure the crosslinked layer by way of photopolymerization and thermal polymerization.

In preparing the crosslinked layer of the photosensitive layer, a radical polymerizable monomer having three or more functionalities is employed, and a photopolymerization initiator as well as a thermal polymerization initiator are utilized, thereby a three-dimensional network is developed, a surface layer is produced with higher hardness and high crosslink density, thereby the crosslinked layer attains higher wear resistance and superior durability.

On the contrary, when radical polymerizable monomers having one or two functionalities are employed exclusively, remarkable improvement of wear resistance cannot be attained since the crosslink density is not sufficiently high in the crosslinked layer. Further, when polymer materials are incorporated previously into the crosslinked layer prior to polymerization, development of three-dimensional network tends to be hindered and the crosslink density is likely to be lower, thus the higher wear resistance cannot be attained; in addition, compatibility is typically poor between the polymer material incorporated previously and reaction product of the radical polymerizable monomer and/or compound which may lead to phase separation, resulting wears and surface flaws at local sites.

Further, in the preparation of the crosslinked layer, the radical polymerizable compound having one functionality exists in the raw material of the crosslinked layer in addition to the radical polymerizable monomer having three or more functionalities, therefore, the radical polymerizable compound having one functionality is included into the crosslinked structure yielded from the radical polymerizable monomer having three or more functionalities. On the contrary, when charge transport substances having a lower molecular mass and no functionality are incorporated into the crosslinked structure, the charge transport substances having a lower molecular mass typically undergo deposition, whiting, or opacity due to their lower compatibility within the crosslinked structure, and the mechanical strength of the resulting crosslinked layer may be lowered. Further, when the raw material of the crosslinked layer contains mainly radical polymerizable compounds having two or more functionalities and a charge transport structure, the radical polymerizable compounds can attach to the crosslinked structure at plural sites; however, the charge transport structure is typically very bulky, thus strain and internal stress are likely to be significant within the crosslinked structure, resulting in frequent occurrences of cracks or flaws of the crosslinked layer.

In accordance with the present invention, the photoconductors can maintain appropriate electric properties for prolonged period, thus higher image quality may be achieved for prolonged period. The reason is believed that the radical polymerizable compound, having one functionality and a charge transport structure, bonds to the crosslinked structure in a condition of pendent groups. On the contrary, charge transport substances having no functionality tend to bring about deposition, whiting, or opacity as described above, and resulting in significant drop of sensitivity and rise of residual potential under repeated usages. Further, radical polymerizable compounds having two or more functionalities and a charge transport structure can attach to the crosslinked structure by plural bonds respectively, therefore, the intermediate structure of radical cation is not stable during charge transportation, and drop of sensitivity and rise of residual potential may be induced due to charge trap. The degradation of electric properties may bring about image defects such as decrease of image density and thinning of letters.

In preparing the photoconductor according to the present invention, although the curing of the crosslinked layer may be attained by one of thermal polymerization initiators and photopolymerization initiators, the uniformity of the crosslinked layer is typically insufficient. In the case of photopolymerization alone, volume shrinkage tends to occur at local sites since the curing generates locally starting from irradiated sites, thereby defects such as wrinkles and cracks may be induced, resulting in unstable quality of the crosslinked layer. In the case of thermal polymerization alone, insufficient curing and unstable quality are typically inevitable since the radical polymerizable monomer cannot be chained along sufficiently long distance during the endothermic period of one to five minutes, for example. In accordance with the present invention, a photopolymerization initiator and a thermal polymerization initiator are utilized in order to cure the crosslinked layer by way of photopolymerization and thermal polymerization, thereby crosslinked layers having higher hardness can be obtained that are uniformly cured and superior in surface smoothness.

The components of the coating liquid for crosslinked layers will be explained in the following that are available for the present invention.

The radical polymerizable monomers having three or more functionalities and no charge transport structure refers to monomers that contain no hole transport structure such as triarylamine, hydrazone, pyrazoline, carbazole and contain no electron transport structure such as fused polycyclic quinone, diphenoquinone, or electron pulling aromatic rings having cyano group or nitro group, instead have three or more radical polymerizable functional groups. The radical polymerizable functional group may be one including at least one carbon-carbon double bond and being radically polymerizable.

Examples of the radical polymerizable functional group include 1-substituted ethylene functional groups and 1,1-substituted ethylene functional groups.

(1) Examples of the 1-substituted ethylene functional groups include functional groups represented by the following formula:
CH₂═CH—X₁— Formula (10)
wherein X₁ represents an arylene group such as phenylene group, naphthylene group and the like, which may be substituted, alkynylene group which may be substituted, —CO— group, —COO— group, —CON(R₁₀)— group (R₁₀ represents a hydrogen atom, alkyl group such as methyl group and ethyl group, aralkyl group such as benzyl group, naphthylmethyl group and phenethyl group, aryl group such as phenyl group and naphthyl group), or —S— group.

Specific examples of the substituents include vinyl group, styryl group, 2-methyl-1,3-butadienyl group, vinylcarbonyl group, acryloyloxy group, acryloylamino group, vinylthioether group, and the like.

(2) Examples of the 1,1-substituted ethylene functional groups include those represented by the following formula:
CH₂═C (Y)−X₂— Formula (11)
wherein Y represents an alkyl group which may be substituted, aralkyl group which may be substituted, aryl group such as phenyl group, naphthyl group which may be substituted, halogen atom, cyano group, nitro group, alkoxy group such as methoxy group and ethoxy group, —COOR₁₁ group (R₁₁ represents a hydrogen atom, alkyl group such as methyl group and ethyl group which may be substituted, aralkyl group such as benzyl and phenethyl groups which may be substituted, aryl groups such as phenyl group and naphthyl group which may be substituted), or —CONR₁₂R₁₃ (R₁₂ and R₁₃ represent a hydrogen atom, alkyl groups such as methyl group and ethyl group which may be substituted, aralkyl group such as benzyl group, naphthylmethyl group, and phenethyl group which may be substituted, aryl group such as phenyl group and naphthyl group which may be substituted, these may be identical or different), X₂ represents a substituent as defined for X₁ of the Formula (10) and a single bond, an alkylene group, provided that at least any one of Y and X₂ is an oxycarbonyl group, cyano group, alkenylene group, and aromatic ring).

Specific examples of these substituents include alpha-chloro acryloyloxy group, methacryloyloxy group, alpha-cyanoethylene group, alpha-cyanoacryloyloxy group, alpha-cyanophenylene group, methacryloylamino group and the like.

Examples of the substituent which is additionally substituted to the subsituents of X₁, X₂ and Y include halogen atoms, nitro group, cyano group, alkyl groups such as methyl group, ethyl group and the like; alkoxy groups such as methoxy group and ethoxy group; aryloxy groups such as phenoxy group; aryl groups such as phenyl group and naphthyl group; and aralkyl groups such as benzyl group and phenethyl group.

Among these radical polymerizable functional groups, acryloyloxy group and methacryloyloxy group are particularly useful. Compounds having three or more of acryloyloxy groups may be prepared, for example, by esterification or transesterification of compounds having three or more hydroxy groups in the molecule with acrylic acid or salt, acrylic acid halide, acrylic acid ester. Also, compounds having three or more methacryloyloxy groups may be similarly prepared. The radical polymerizable functional groups in a monomer having three or more functionalities may be identical or different.

Specific examples of radical polymerizable monomers having three or more functionalities and no charge transport structure are listed below, but not limited to.

The radical polymerizable monomers, available in the present invention, include trimethylolpropanetriacrylate (TMPTA), trimethylolprop anetrimethacrylate, HPA-modified trimethylolprop anetriacrylate, EO-modified trimethylolprop ane triacrylate, PO-modified trimethylolpropane triacrylate, caprolactone-modified trimethylolprop ane triacrylate, HPA-modified trimethylolprop ane trimethacrylate, pe ntaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl)isocyanurate, dipentaerythritol hexacrylate (DPHA), caprolactone-modified dipentaerythritol hexacrylate, dipentaerythritolhydroxy pentaacrylate, alkyl-modified dipe ntaerythritol pentaacrylate, alkyl-modified dipe ntaerythritol tetraacrylate, alkyl-modified dipentaerythritol triacrylate, dimethylolpropane tetraacrylate (DTMPTA), pentaerythritolethoxy tetraacrylate, EO-modified phosphonic acid triacrylate, 2,2,5,5,-tetrahydroxymethylcyclopentanone tetraacrylate and the like. These may be used alone or in combination.

Preferably, the radical polymerizable monomer having three or more functionalities and no charge transport structure employed in the present invention has a ratio of molecular mass to functionalities (molecular mass÷number of functional groups) of 250 or less in order to attain higher crosslink density within the crosslinked layer. More preferably, the ratio of molecular mass to functionalities is 80 to 250. When the ratio is greater than 250, the crosslinked layer tends to be soft and the wear resistance may be somewhat poor; therefore, when a monomer is employed that has a modified group such as HPA, EO and PO, the monomer having an excessively long modified group is preferably not employed alone.

Preferably, the content of the radical polymerizable monomer having three or more functionalities is 20 to 80% by mass, more preferably is 30 to 70% by mass based on the total mass of the crosslinked layer. When the content of the radical polymerizable monomer is less than 20% by mass, significant improvement of wear resistance may not be attained compared to the conventional thermoplastic binder resins, since the three-dimensional crosslink density is lower in the crosslinked layer, and when the content of the radical polymerizable monomer is more than 80% by mass, the electrical properties are deteriorated since the charge transport property is insufficient. From the viewpoint of wear resistance and electrical properties, the content of the radical polymerizable monomer is preferably 30 to 70% by mass.

The radical polymerizable compounds having one functionality and a charge transport structure may be those having a hole transport structure such as triarylamine, hydrazone, pyrazoline, and carbazole, or those having an electron transport structure such as fused polycyclic quinone, diphenoquinone, and an electron pulling aromatic ring having a cyano group or nitro group, and also having one radical polymerizable functional group. Examples of the radical polymerizable functional groups may be those illustrated in terms of the radical polymerizable monomer. Preferably, the functional group of the radical polymerizable compound having one functionality is acryloyloxy group or methacryloyloxy group.

Preferably, the charge transport structure of the radical polymerizable compound having one functionality contains a triarylamine structure, in particular, the radical polymerizable compound having one functionality is selected from the compounds expressed by General Formulas (1) and (2) from the viewpoints of higher sensitivity and appropriate electric properties. 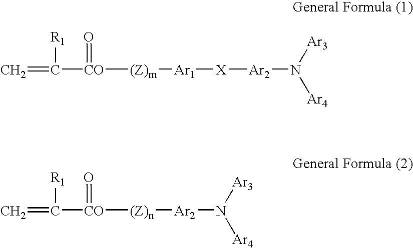
wherein R₁ represents a hydrogen atom, halogen atom, alkyl group which may be substituted, aralkyl group which may be substituted, aryl group which may be substituted, cyano group, nitro group, alkoxy group, —COOR₇ (R₇ represents a hydrogen atom, alkyl group which may be substituted, aralkyl group which may be substituted, or aryl group which may be substituted), halogenated carbonyl group, or CONR₈R₉ (R₈ and R₉ each represents a hydrogen atom, halogen atom, alkyl group which may be substituted, aralkyl group which may be substituted, or aryl group which may be substituted, R₈ and R₉ may be identical or different); Ar₁ and Ar₂ each represents a substituted or unsubstituted arylene group which may be identical or different; Ar₃ and Ar₄ each represents a substituted or unsubstituted aryl group which may be identical or different; X represents a single bond, substituted or unsubstituted alkylene group, substituted or unsubstituted cycloalkylene group, substituted or unsubstituted alkylene ether group, oxygen atom, sulfur atom, or vinylene group; Z represents a substituted or unsubstituted alkylene group, substituted or unsubstituted alkylene ether group, or alkyleneoxycarbonyl group; “m” and “n” each represents an integer of 0 to 3.

More specifically, with respect to substituents of R₁ in the general Formulas (1) and (2), examples of the alkyl group include methyl group, ethyl group, propyl group, butyl group etc., examples of the aralkyl group include benzyl group, phenethyl group, naphthylmethyl group etc., examples of the aryl group include phenyl group, naphthyl group etc., examples of the alkoxy group include methoxy group, ethoxy group, propoxy group etc.; these groups may be substituted further by a halogen atom, nitro group, cyano group, alkyl group such as methyl group, ethyl group etc., alkoxy group such as methoxy group, ethoxy group and the like, aryloxy group such as phenoxy group and the like, aryl group such as phenyl group, naphthyl group and the like, aralkyl group such as benzyl group, phenethyl group and the like.

Particularly preferable substituents of R₁ are a hydrogen atom and methyl group.

Ar₃ and Ar₄ are each a substituted or unsubstituted aryl group; examples of the aryl group include fused polycyclic hydrocarbon groups, non-fused cyclic hydrocarbon groups, and heterocyclic groups.

The fused polycyclic hydrocarbon group is preferably one having 18 or less carbon atoms to form a ring, examples thereof include pentanyl group, indenyl group, naphthyl group, azulenyl group, heptaprenyl group, biphenylenyl group, as-indacenyl group, s-indacenyl group, fluorenyl group, acenaphthylenyl group, pleiadene adenyl group, acenaphthenyl group, phenalenyl group, phenathryl group, antholyl group, fluorandenyl group, acephenanthrylenyl group, aceanthrylenyl group, triphenylenyl group, pyrenyl group, chrysene, and naphthacenyl group.

Examples of the non-fused hydrocarbon group include a monovalent group of monocyclic hydrocarbon compounds such as benzene, diphenyl ether, polyethylenediphenyl ether, diphenylthioether and diphenylsulphone, a monovalent group of non-fused polycyclic hydrocarbon compounds such as biphenyl, polyphenyl, diphenylalkane, diphenylalkene, diphenylalkyne, triphenylmethane, distyrylbenzene, 1,1-diphenylcycloalkane, polyphenylalkane and polyphenylalkene, or a monovalent group of cyclic hydrocarbon compounds such as 9,9-diphenylfluorene.

Examples of the heterocyclic group include a monovalent group of carbazole, dibenzofuran, dibenzothiphene, oxadiazole, and thiadiazole.

The aryl group represented by Ar₃ and Ar₄ may be substituted by the substituents described below.
(1) halogen atom, cyano group, nitro group and the like.
(2) alkyl group, preferably C₁ to C₁₂, particularly C₁ to C₈, more preferably C₁ to C₄ straight-chained or branched alkyl group, wherein the alkyl group may be further substituted by a fluorine atom, hydroxy group, cyano group, C₁ to C₄ alkoxy group, phenyl group, or phenyl group substituted by a halogen atom, C₁ to C₄ alkyl group or C₁ to C₄ alkoxy group. Specific examples thereof include methyl group, ethyl group, n-butyl group, i-propyl group, t-butyl group, s-butyl group, n-propyl group, tri-fluoromethyl group, 2-hydroxyethyl group, 2-ethoxyethyl group, 2-cyanoethyl group, 2-methoxyethyl group, benzyl group, 4-chlorobenzyl group, 4-methylbenzyl group, 4-phenylbenzyl group and the like.
(3) alkoxy group (—OR₂), wherein R₂ represents an alkyl group as described in (2). Specific examples thereof include methoxy group, ethoxy group, n-propoxy group, i-propoxy group, t-butoxy group, n-butoxy group, s-butoxy group, i-butoxy group, 2-hydroxyethoxy group, benzyloxy group, tri-fluoromethoxy group and the like.
(4) aryloxy group, wherein the aryl group may be phenyl group and naphthyl group, which may be substituted by C₁ to C₄ alkoxy group, C₁ to C₄ alkyl group, or halogen atom. Specific examples thereof include phenoxy group, 1-naphthyloxy group, 2-naphthyloxy group, 4-methoxyphenoxy group, 4-methylphenoxy group and the like.
(5) alkylmercapto group or arylmercapto group. Specific examples thereof include methylthio group, ethylthio group, phenylthio group, p-methylphenylthio group and the like. 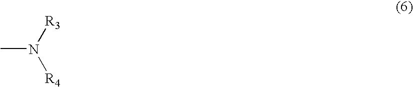
wherein R₃ and R₄ each represents independently a hydrogen atom, alkyl group as described in (2), or aryl group. Examples of the aryl group include phenyl group, biphenyl group, or naphthyl group which may be substituted by C₁ to C₄ alkoxy group, C₁ to C₄ alkyl group, or halogen atom, or R₃ and R₄ may form a ring together with.

Specific examples thereof include amino group, diethylamino group, N-methyl-N-phenylamino group, N,N-diphenylamino group, N,N-di(tryl)amino group, dibenzylamino group, piperidino group, morpholino group, pyrrolidono group, and the like.
(7) alkylenedioxy group or alkylenedithio group such as methylenedioxy group or methylenedithio group.
(8) substituted or unsubstituted styryl group, substituted or unsubstituted β-phenylstyryl group, diphenylaminophenyl group, ditolylaminophenyl group, and the like.

The arylene groups represented by Ar₁ and Ar₂ include divalent groups derived from aryl groups represented by Ar₃ and Ar₄.

X represents a single bond, substituted or unsubstituted alkylene group, substituted or unsubstituted cycloalkylene group, substituted or unsubstituted alkylene ether group, oxygen atom, sulfur atom, or vinylene group.

Examples of the substituted or unsubstituted alkylene groups are C₁ to C₁₂, preferably C₁ to C₈, more preferably C₁ to C₄ straight chained or branched alkylene groups, wherein the alkylene groups may be further substituted by a fluorine atom, hydroxy group, cyano group, C₁ to C₄ alkoxy groups, phenyl group, or phenyl group substituted by a halogen atom, C₁ to C₄ alkyl group, or C₁ to C₄ alkoxy group. Specific examples thereof include methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-methoxyethylene group, benzylidene group, phenylethylene group, 4-chlorophenylethylene group, 4-methylphenylethylene group, 4-biphenylethylene group and the like.

Examples of the substituted or unsubstituted cycloalkylene groups include C₅ to C₇ cyclic alkylene groups, wherein the cyclic alkylene groups may be substituted by a fluorine atom, hydroxide group, C₁ to C₄ alkyl group, or C₁ to C₄ alkoxy group. Specific examples thereof include cyclohexylidene group, cyclohexylene group, 3,3-dimethylcyclohexylidene group and the like.

Examples of the substituted or unsubstituted alkylene ether group include ethyleneoxy group and propyleneoxy group, wherein the alkylene group may be substituted by a hydroxyl group, methyl group, ethyl group and the like.

The vinylene group may be represented by the following formula. 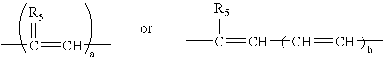
wherein R₅ represents a hydrogen atom, alkyl group which is the same as described in (2), or aryl group which is the same with the aryl group represented by Ar₃ and Ar₄; “a” represents an integer of 1 or 2, and “b” represents an integer of 1 to 3.

Z represents a substituted or unsubstituted alkylene group, substituted or unsubstituted alkylene ether group, or alkyleneoxycarbonyl group. The substituted or unsubstituted alkylene group includes the alkylene groups as defined for X. The substituted or unsubstituted alkylene ether group includes the alkylene ether groups as defined for X. The alkyleneoxycarbonyl group includes caprolactone-modified groups.

Preferable examples of the radical polymerizable compounds having one functionality and a charge transport structure are those expressed by General Formula (3). 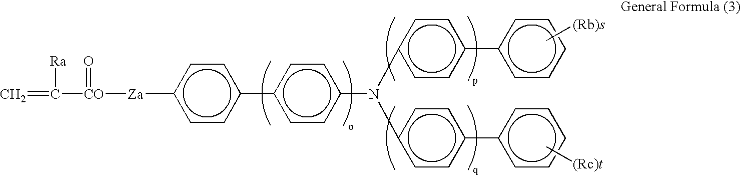
wherein “o,” “p”, and “q” each represents an integer of 0 or 1, Ra represents a hydrogen atom or methyl group, Rb and Rc each represent a substituent other than a hydrogen atom which is a C₁₋₆ alkyl group and may be different when they are two or more, “s” and “t” each represents an integer of 0 to 3, and Za represents a single bond, methylene group, ethylene group, or group expressed by the following formulas:

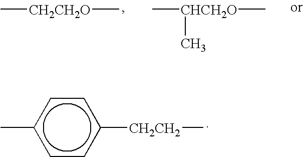

The compounds represented by the above formula are preferably those in which Rb and Rc are each methyl group or ethyl group.

The radical polymerizable compounds having one functionality and a charge transport structure expressed by Formulas (1), (2), and (3), in particular those expressed by Formula (3) typically do not attach to terminal sites of crosslinked structure sine the polymerization is accomplished by opening of the carbon-carbon double bond at both sides, but are possibly incorporated into a continuous polymer chain. The radical polymerizable compound having one functionality exists, within the crosslinked polymer formed with the radical polymerizable monomer having three or more functionalities, at the main chain or the cross linking chain between main chains. Incidentally, crosslinking chains can be classified into intermolecular crosslinking chains, and intramolecular crosslinking chains that connect certain sites within a molecule. In both cases of existence at the main chain and at the cross linking chain of the radical polymerizable compound having one functionality, the triarylamine structure attached to the chain is bulky due to at least three aryl groups attached radially to the nitrogen atom. However, since the three aryl groups are not directly attached to the chains but are indirectly attached to the chains through carbonyl group or the like, it is believed that the triarylamine structure is fixed flexibly in terms of spatial site, and the triarylamine structure can be disposed at appropriate distances therebetween, therefore, structural stress is not significant in the molecules and the passages for charge transport can be maintained in the molecular structure within the surface layer of photoconductors.

Specific examples of the radical polymerizable compounds having one functionality and a charge transport available in the present invention are listed below, but are not limited to.

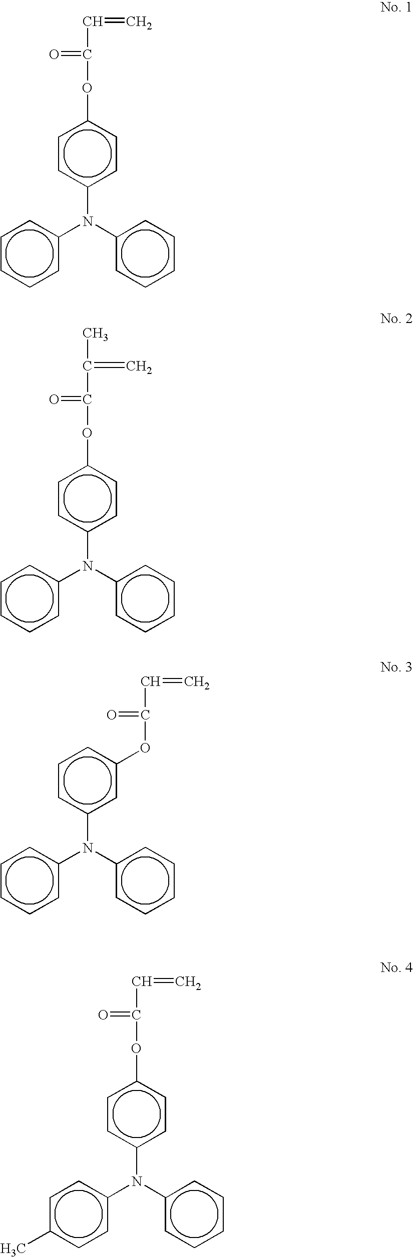

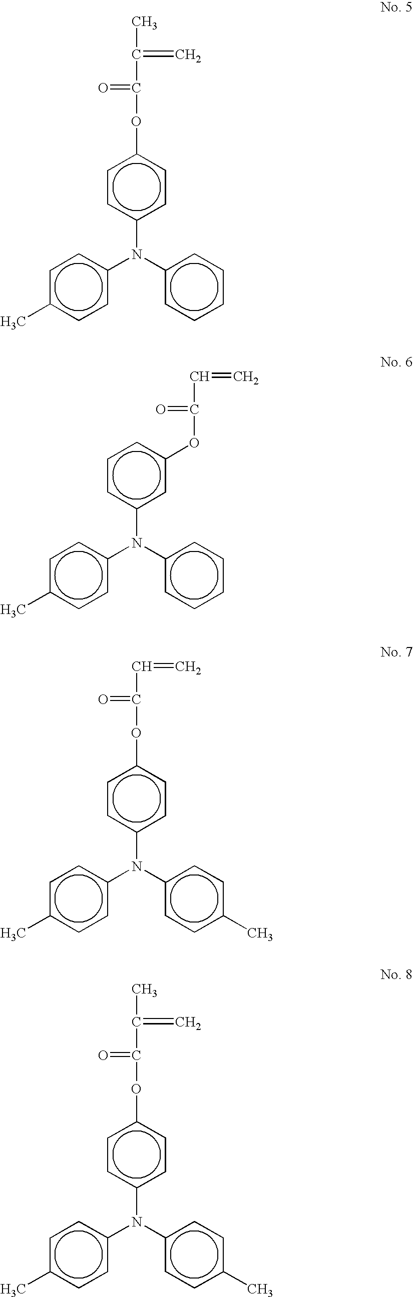

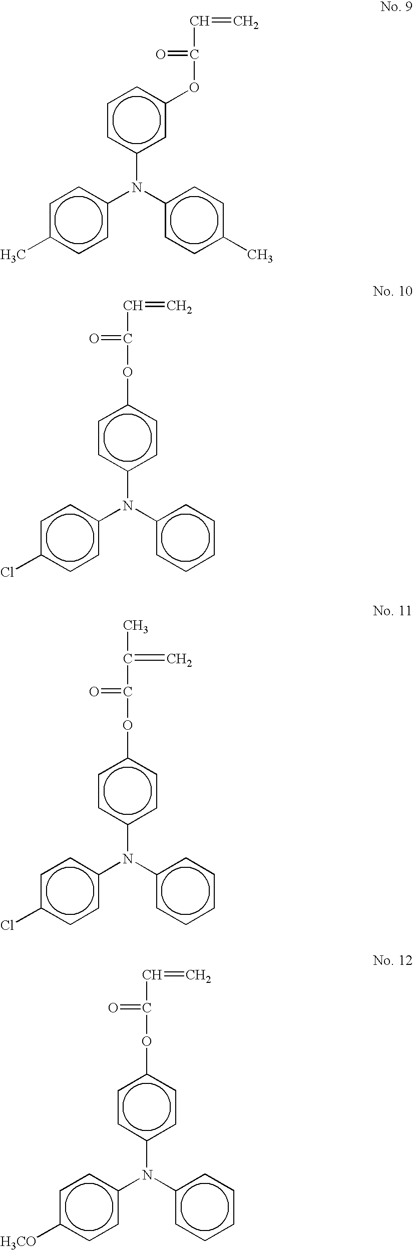

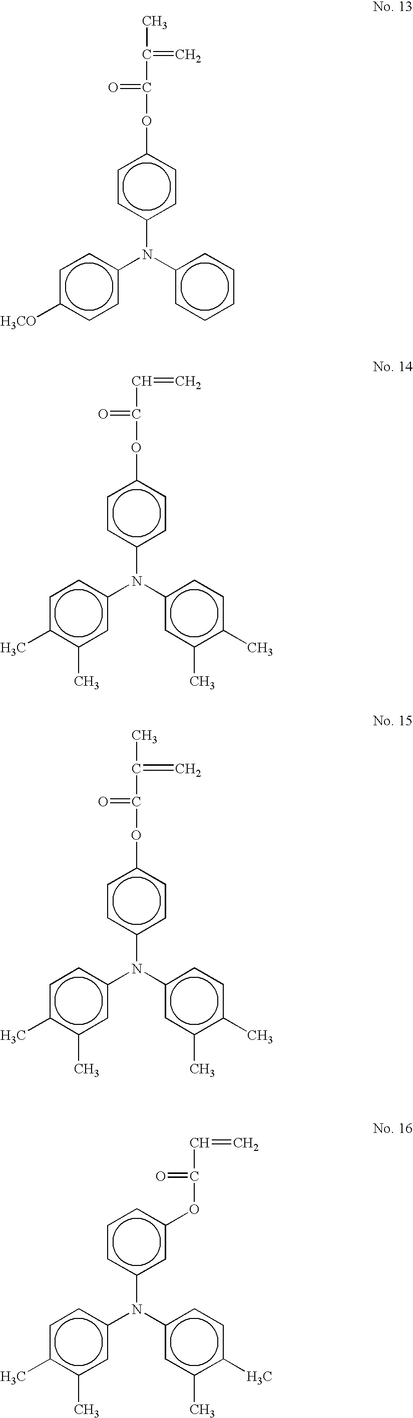

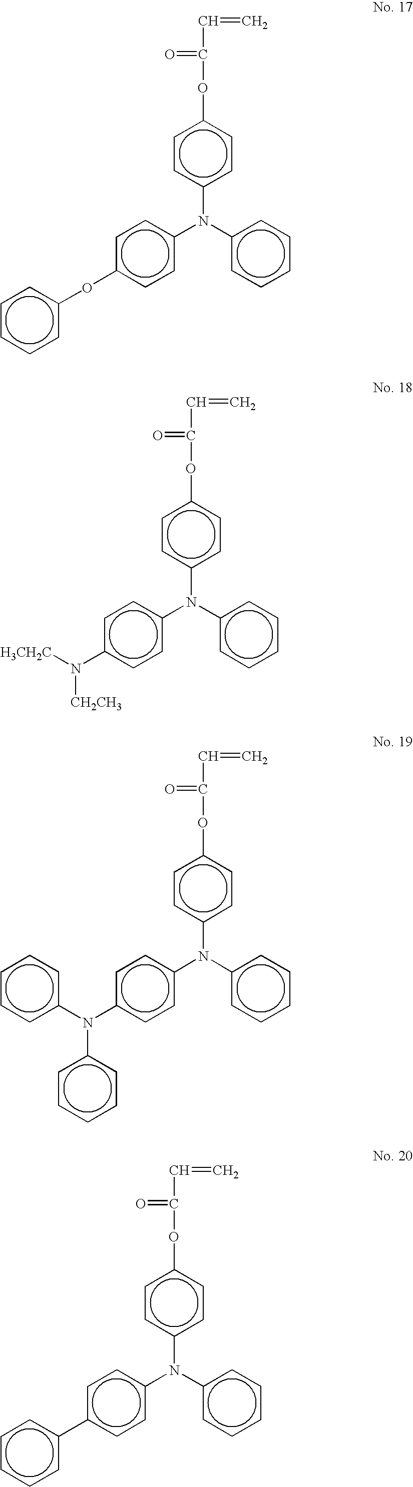

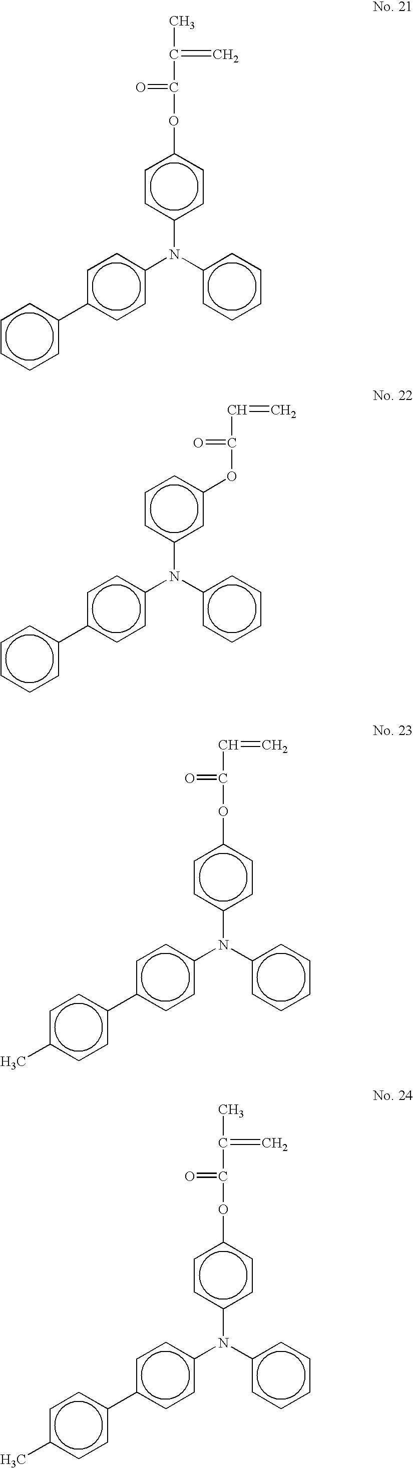

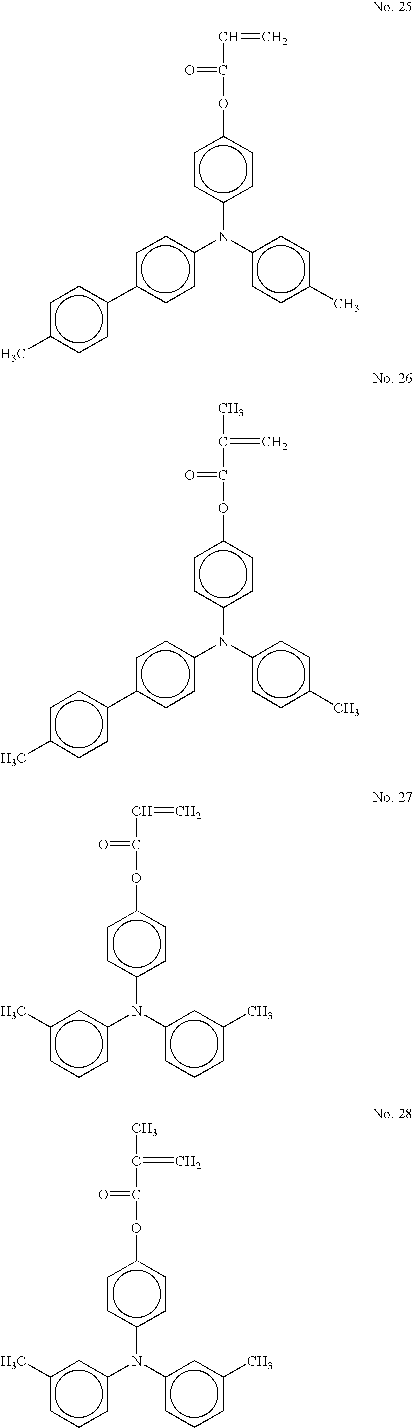

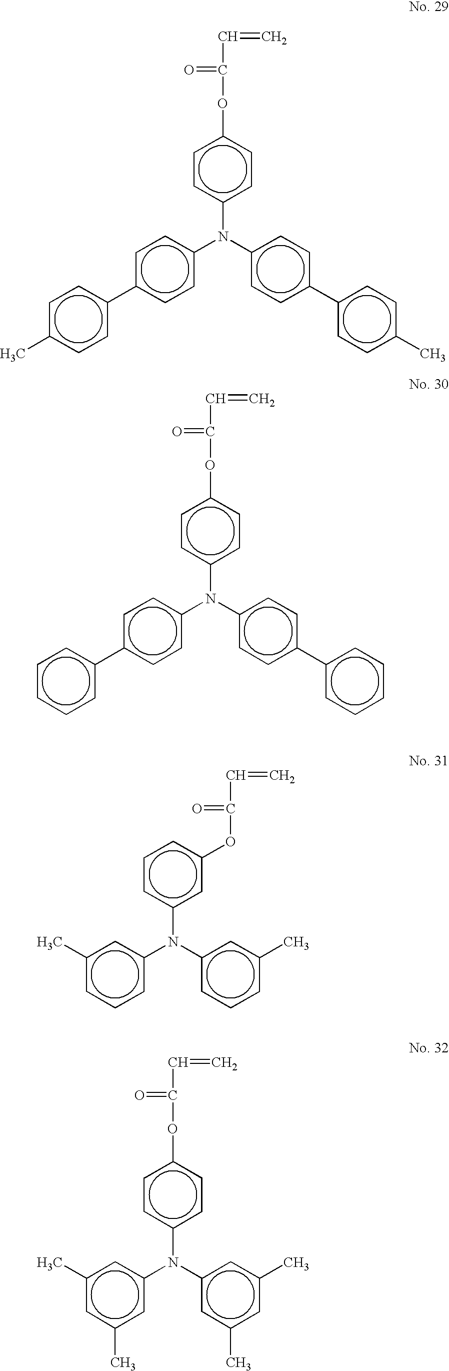

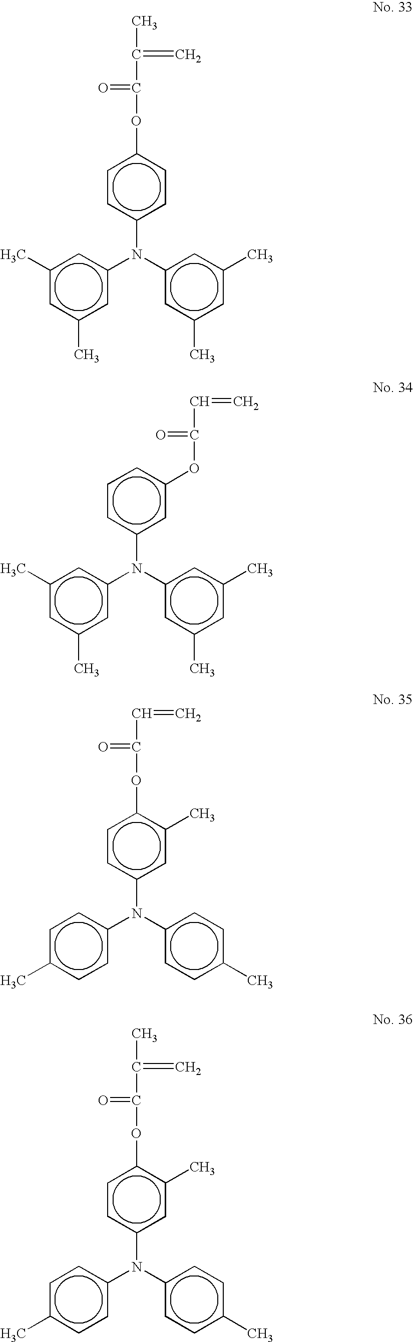

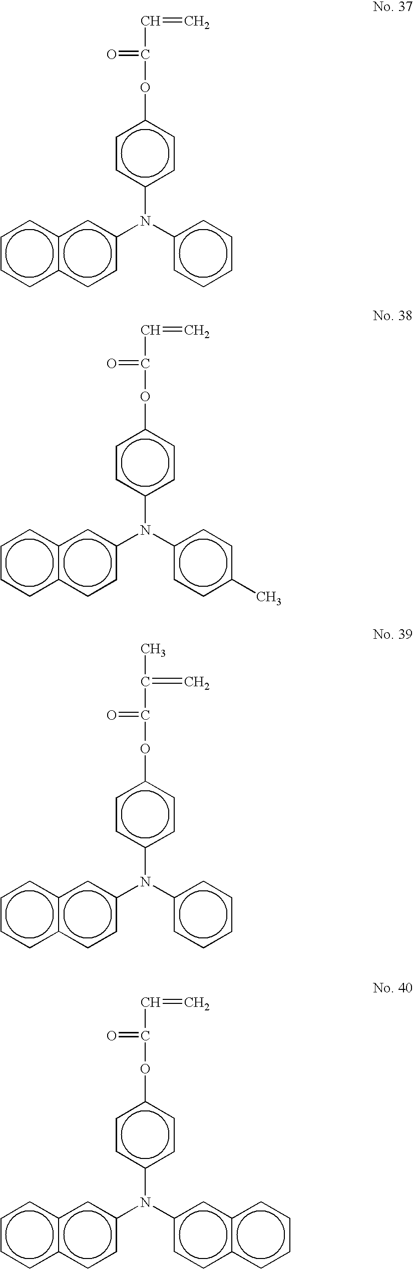

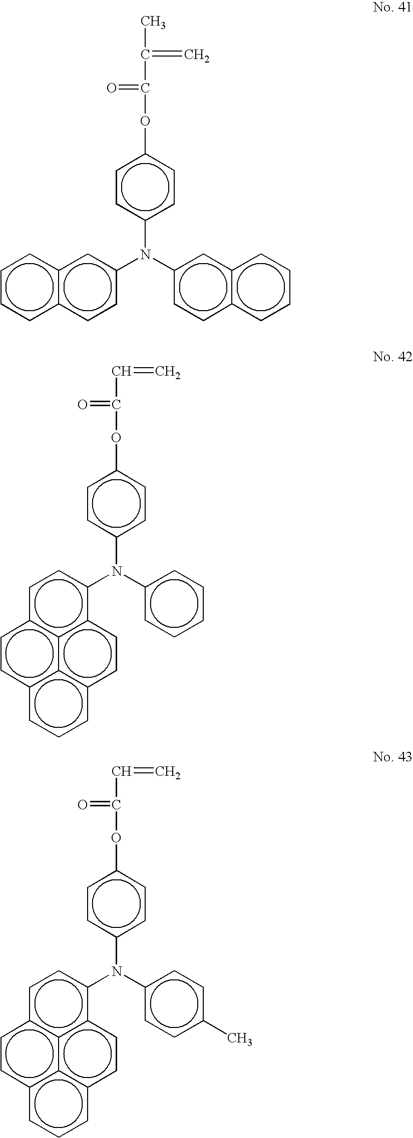

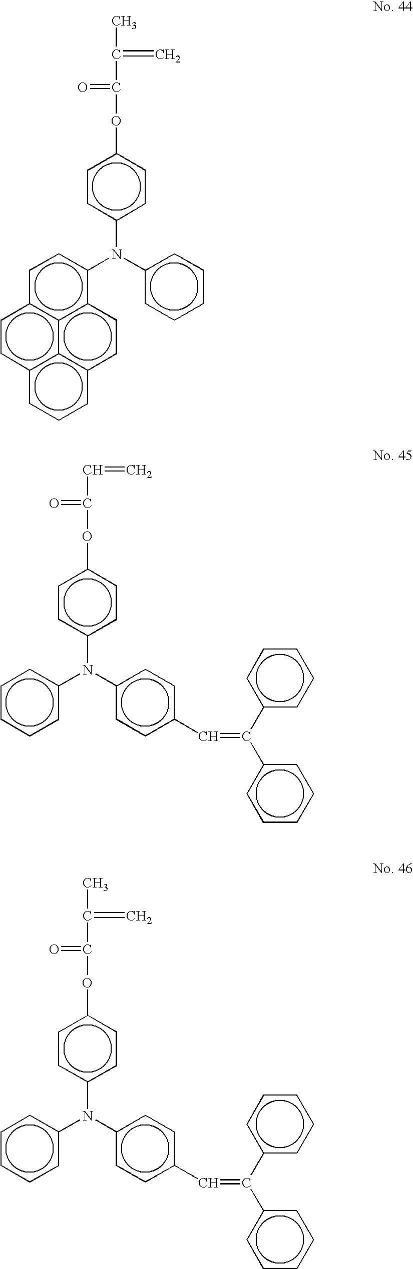

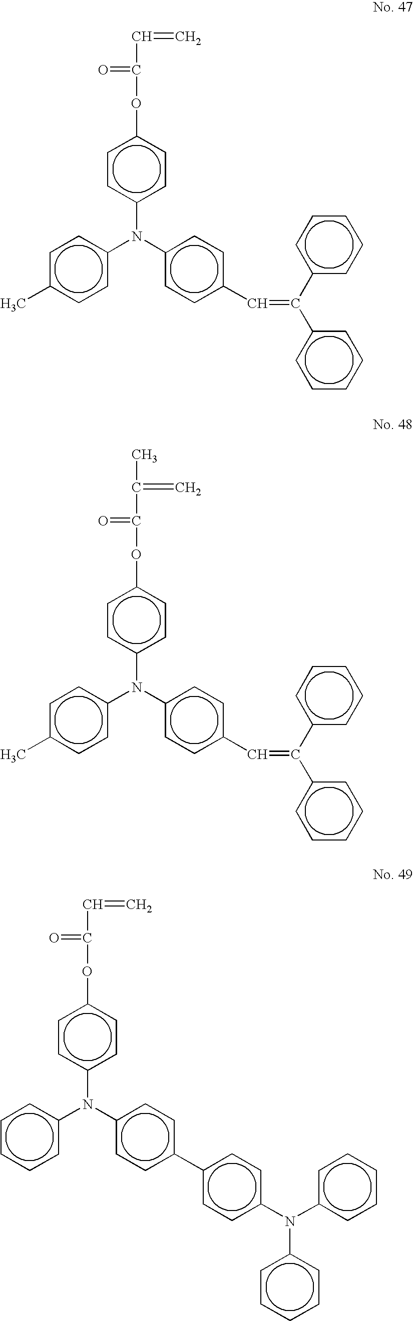

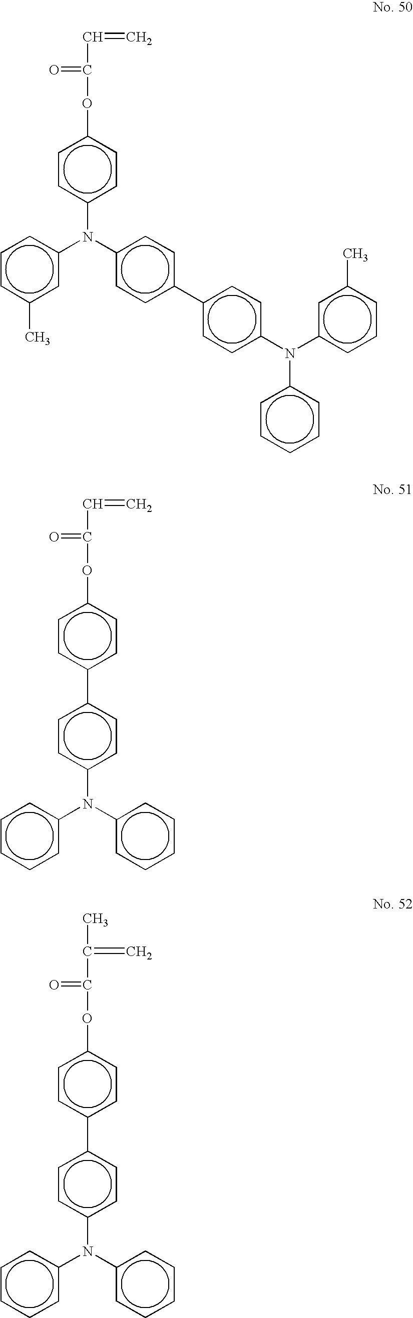

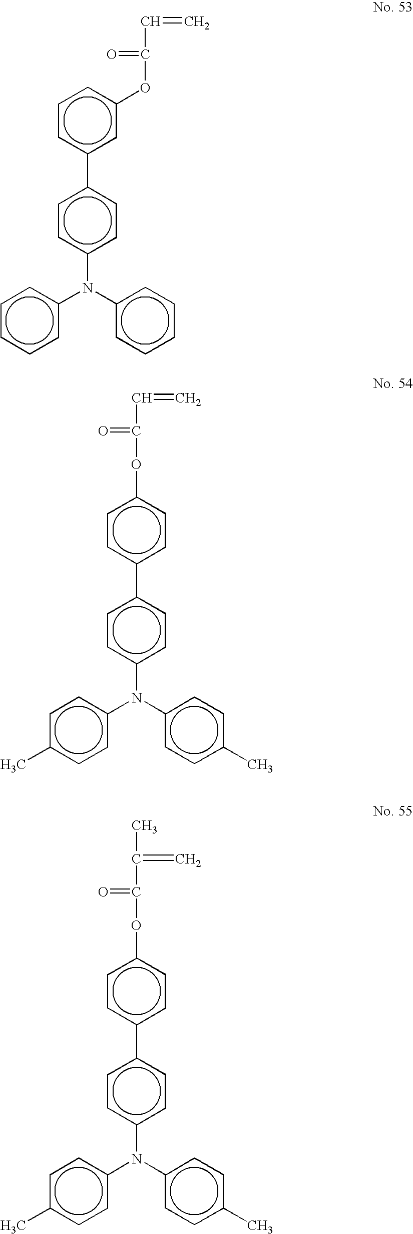

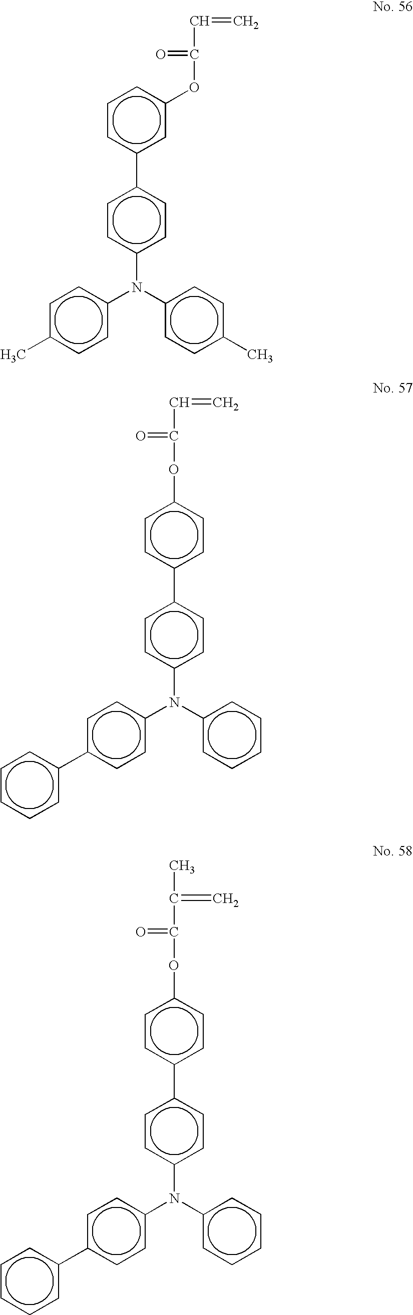

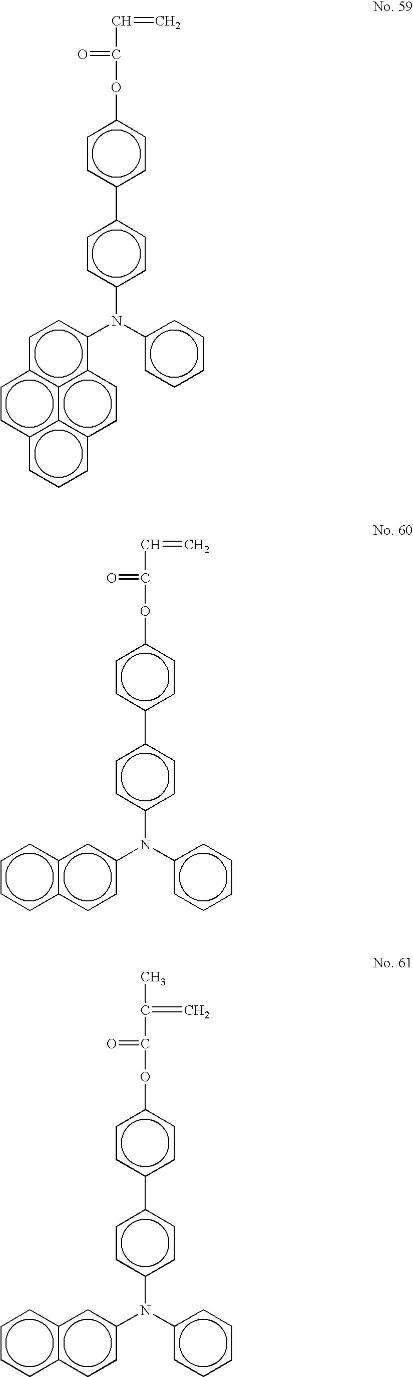

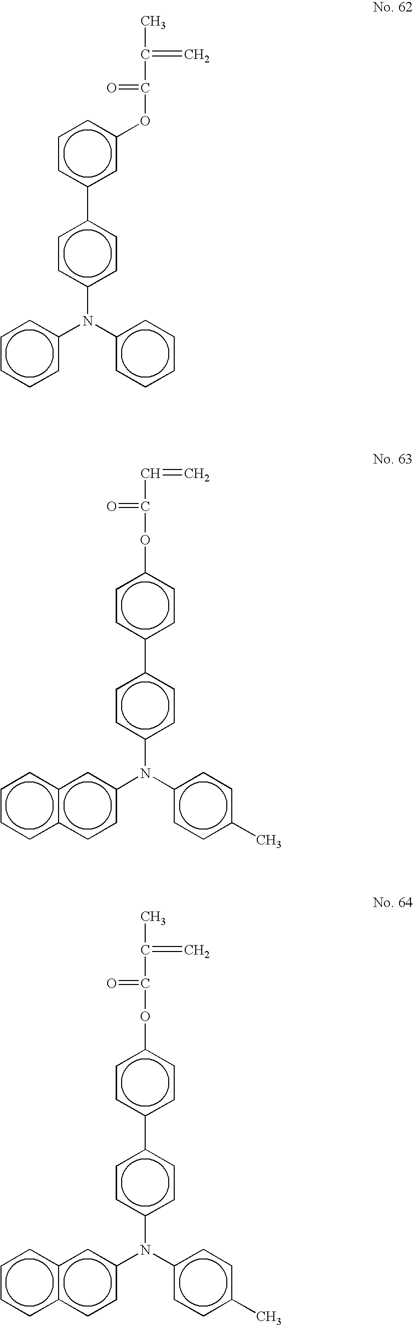

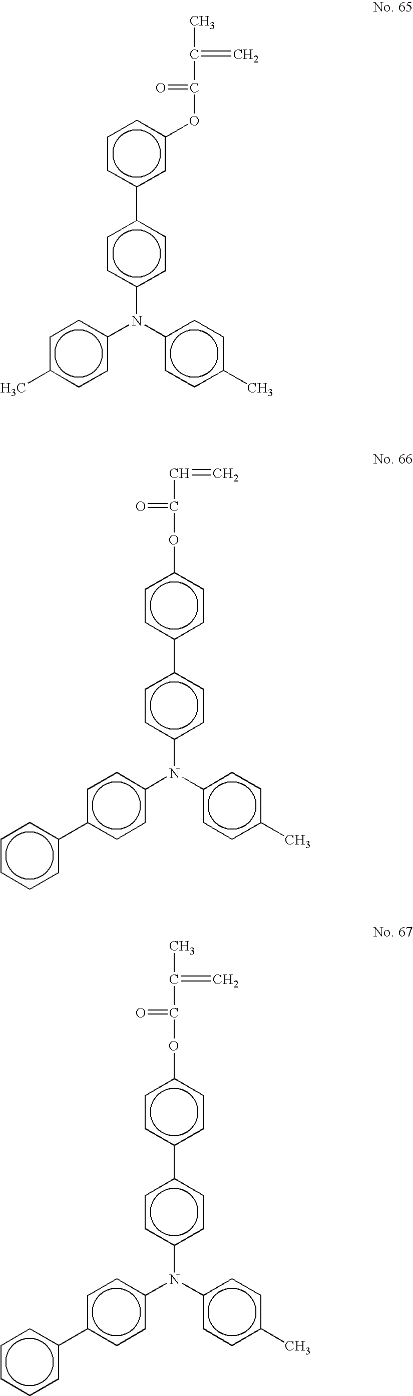

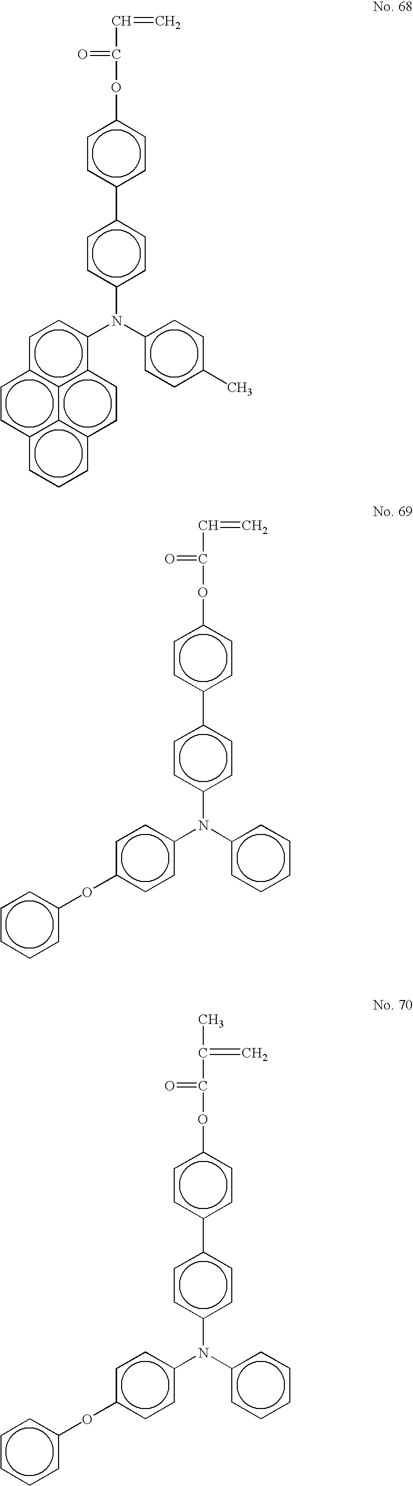

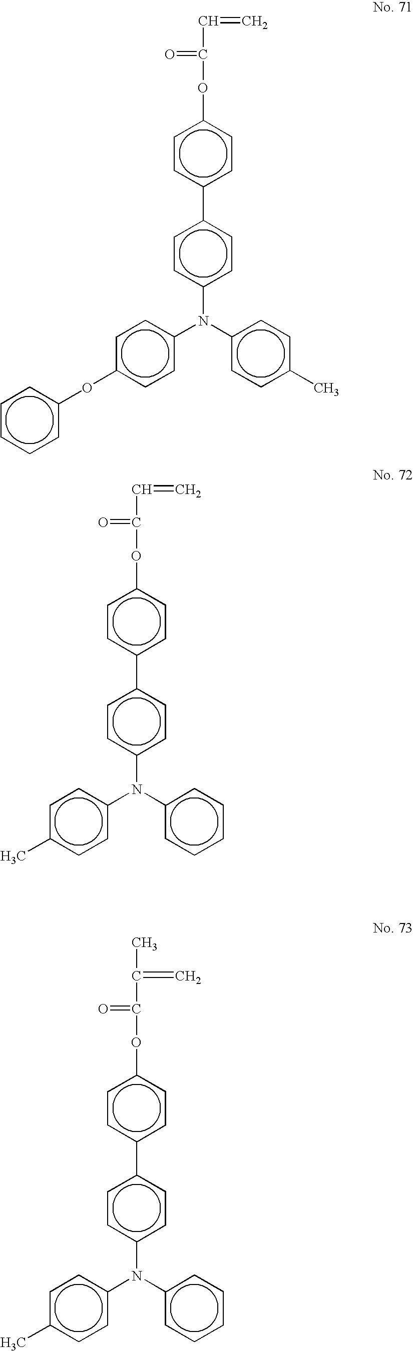

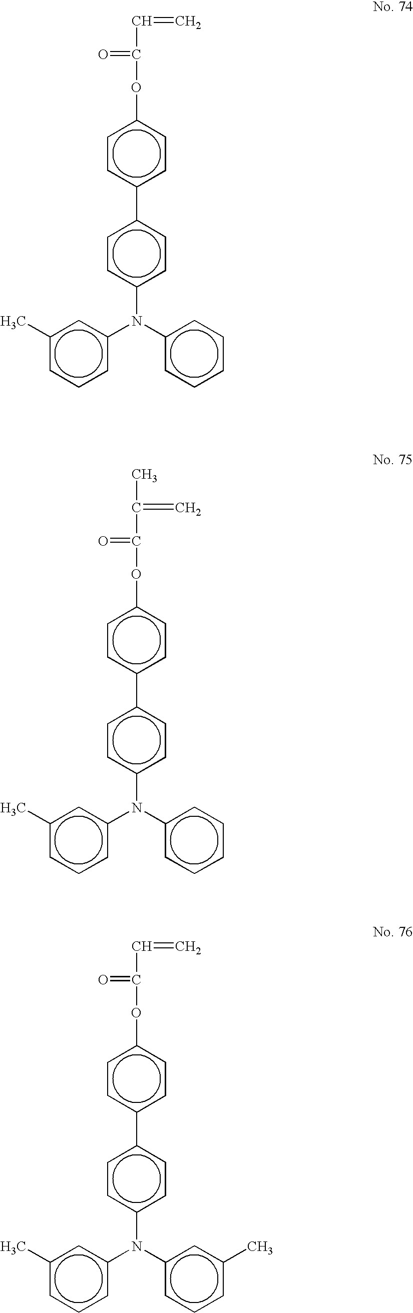

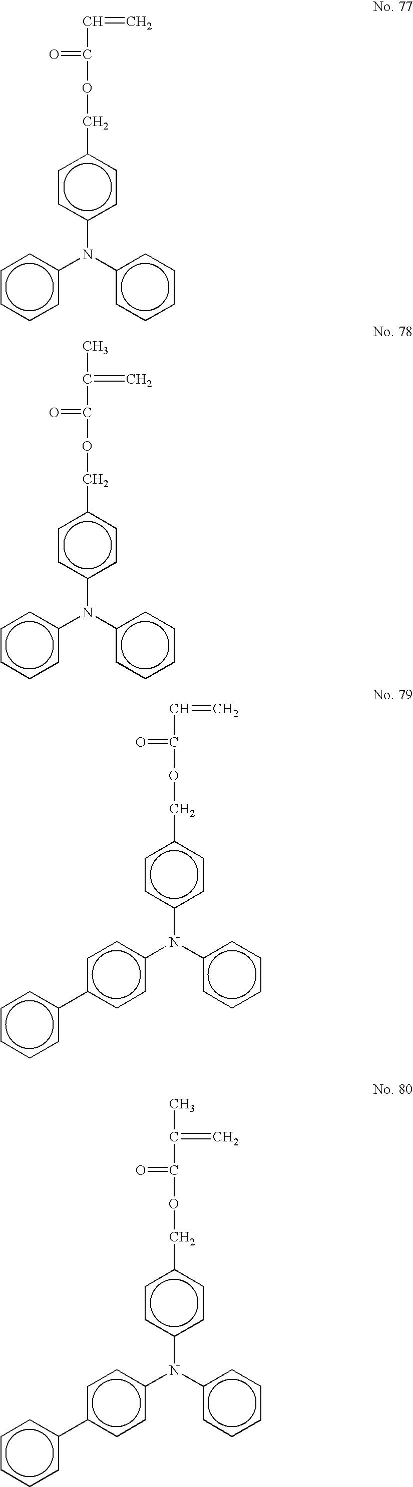

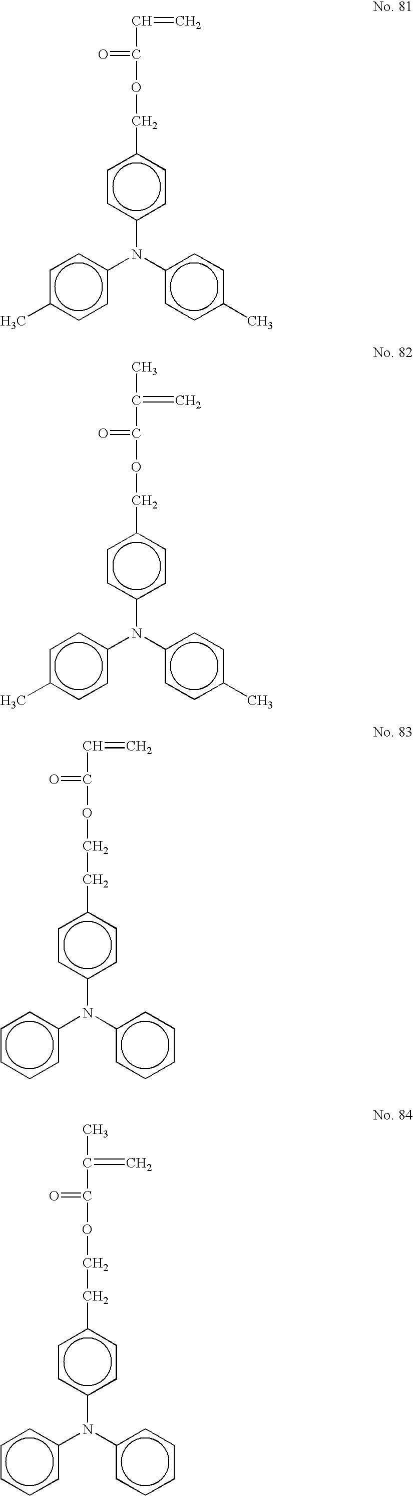

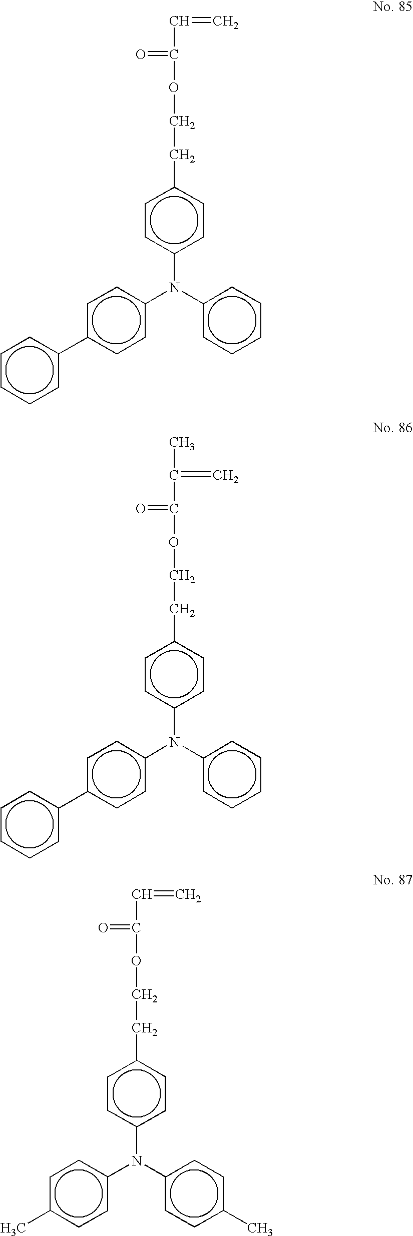

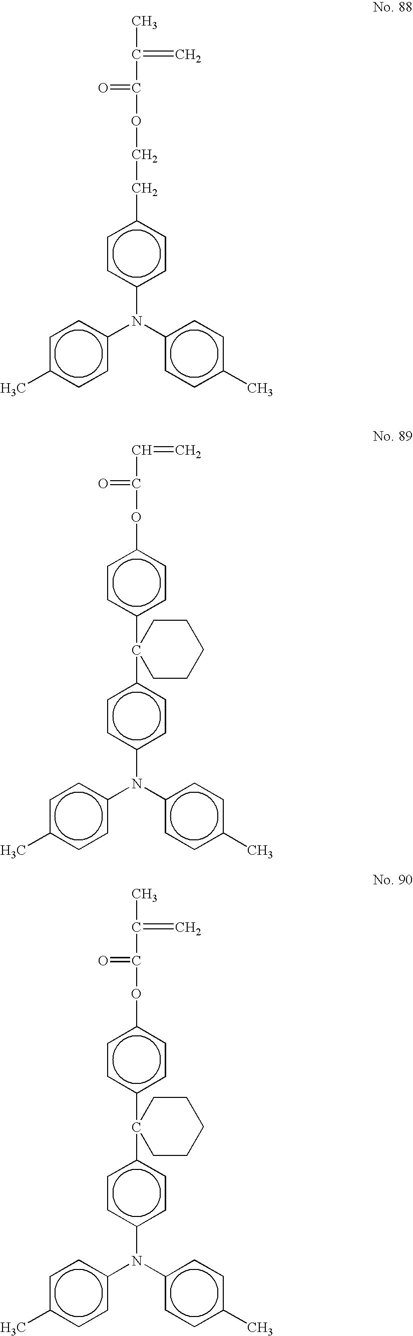

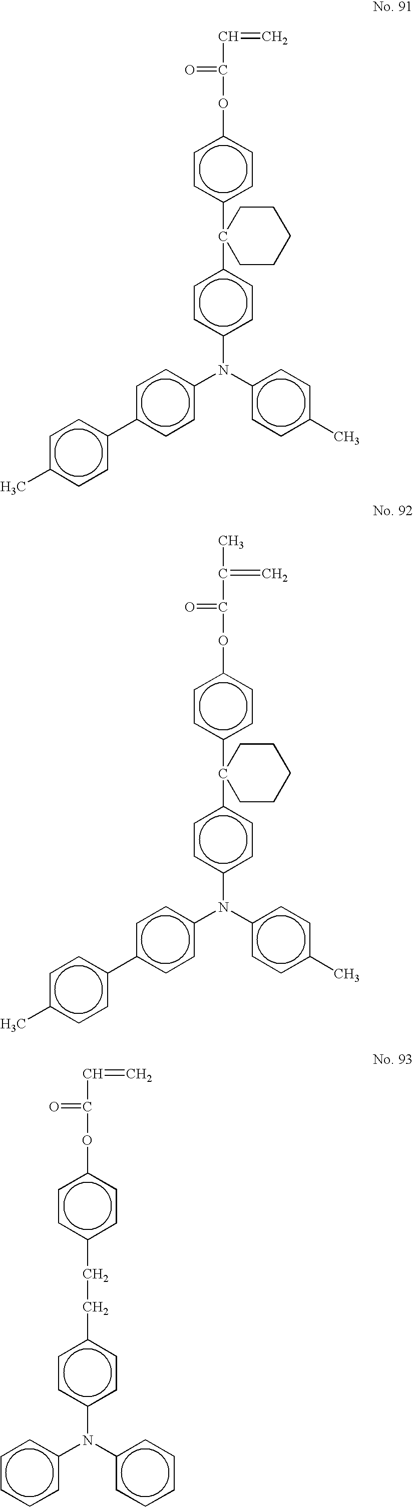

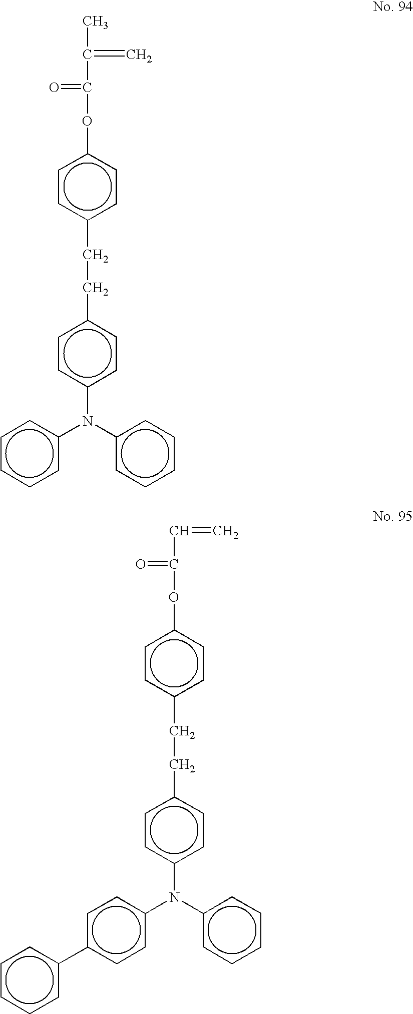

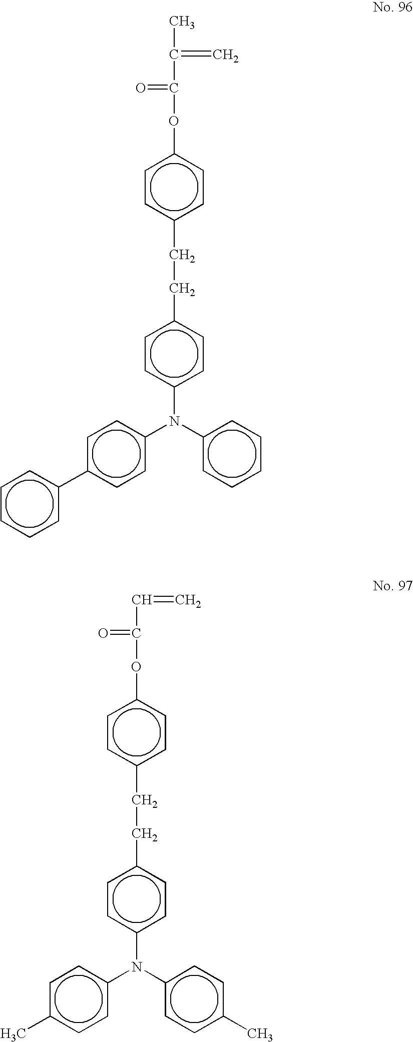

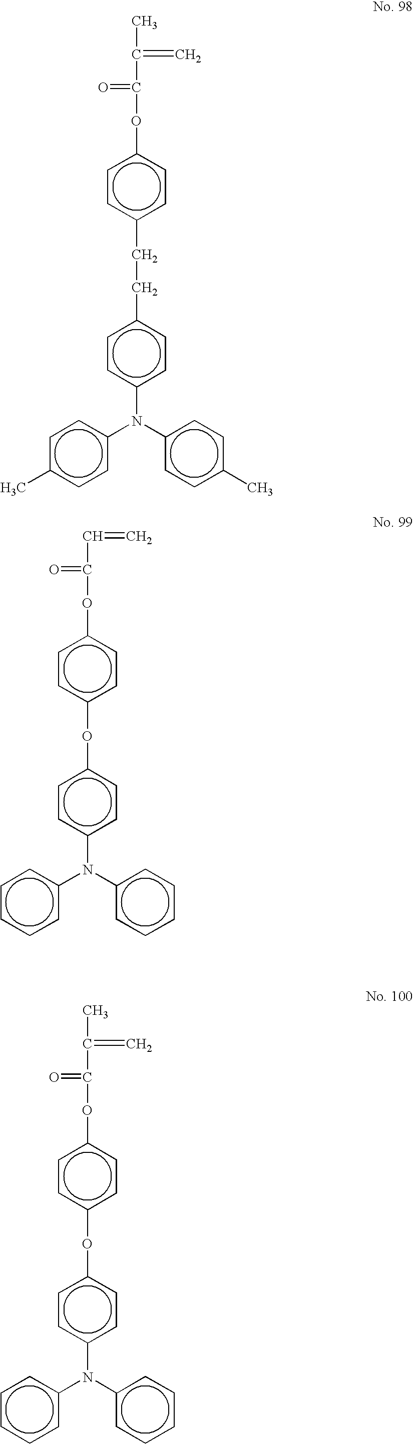

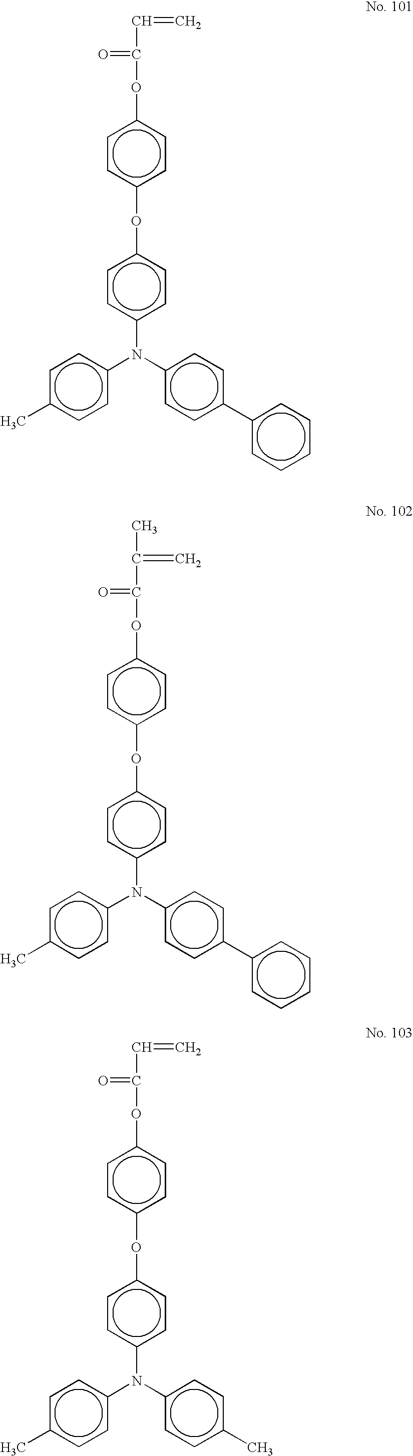

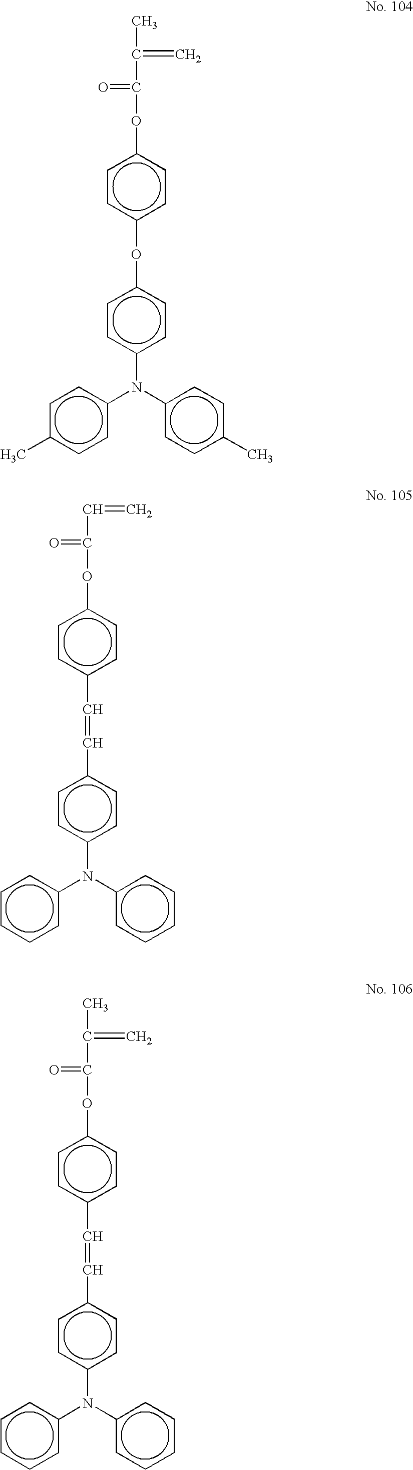

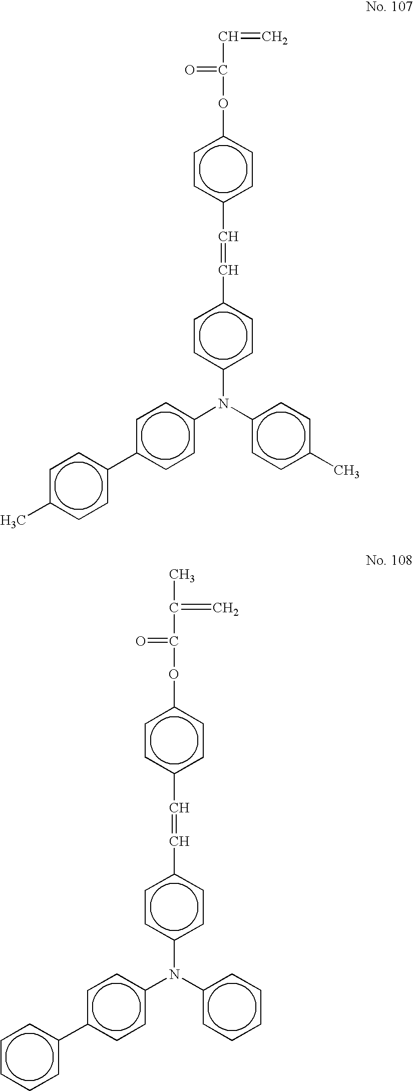

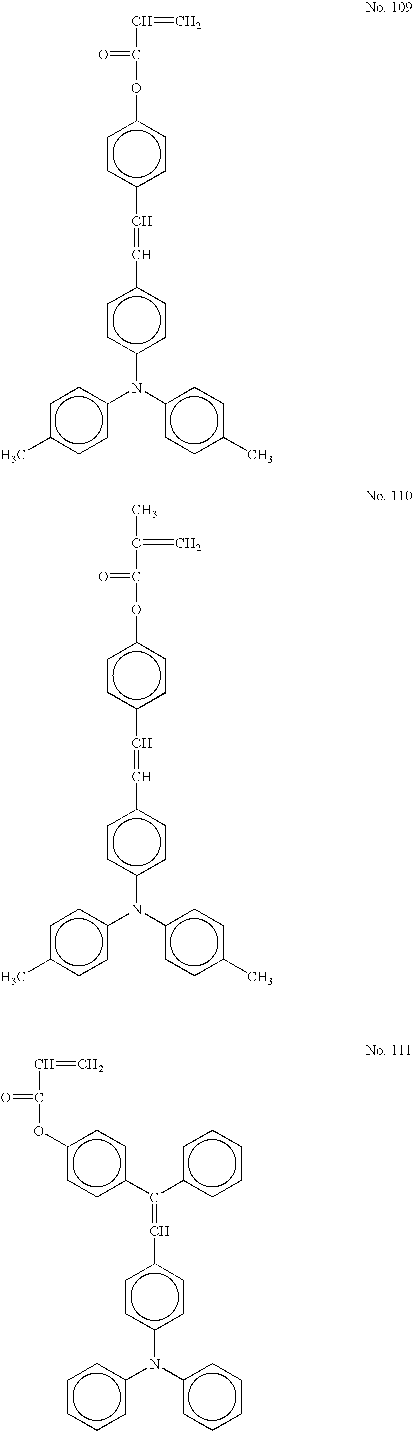

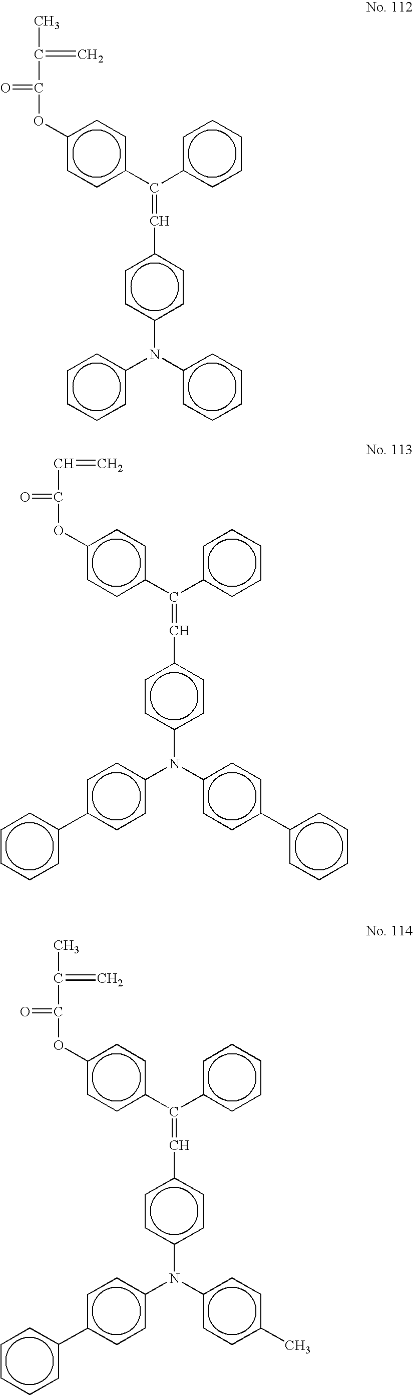

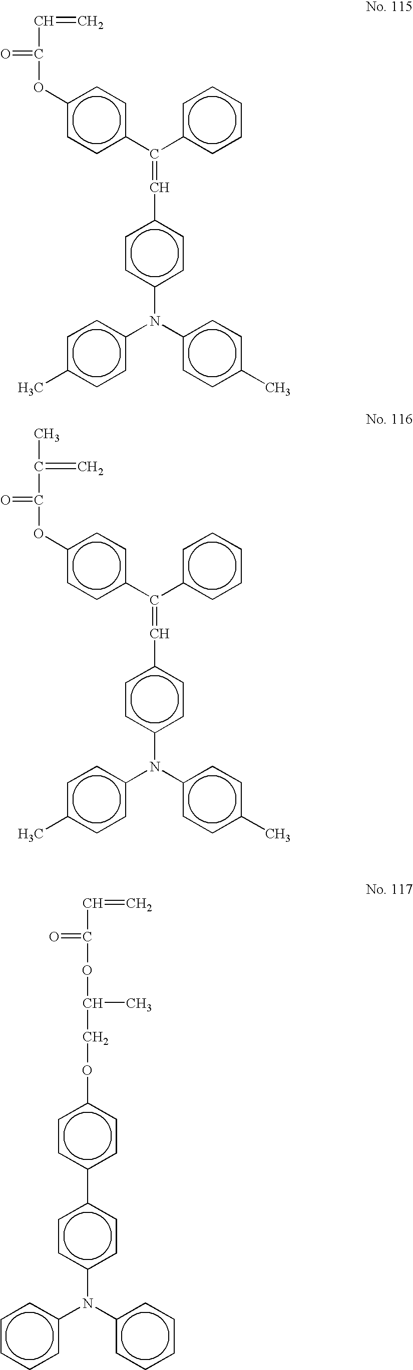

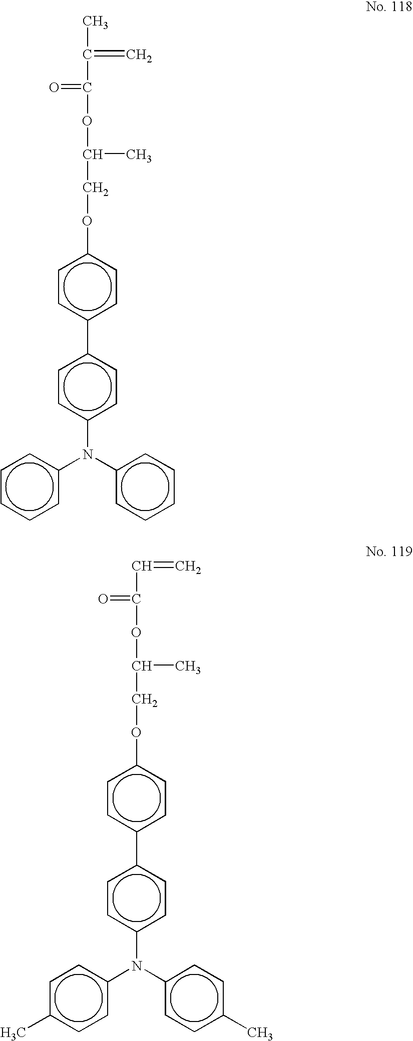

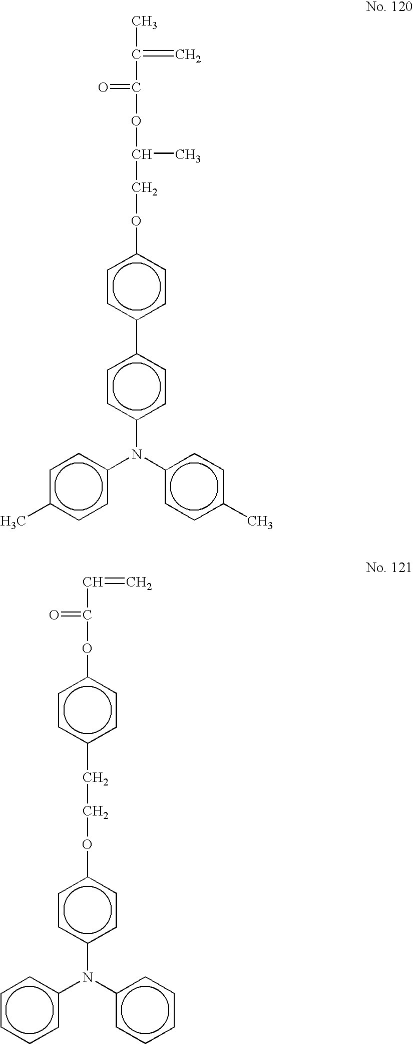

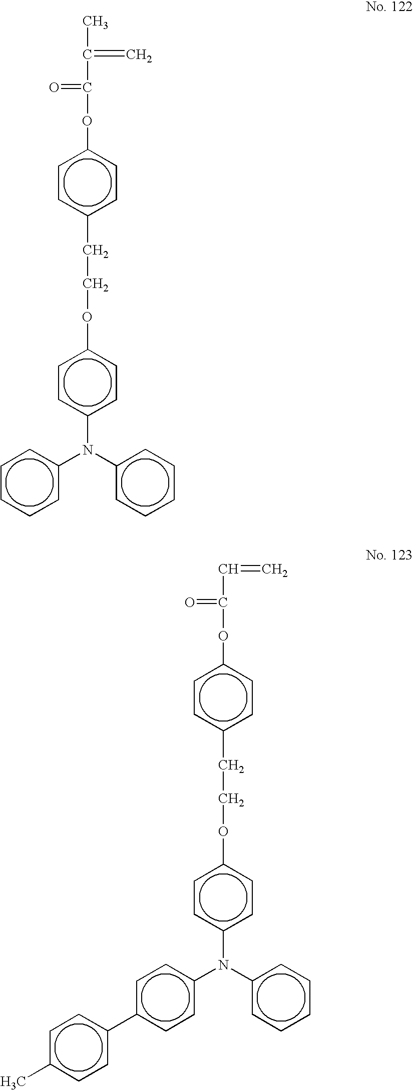

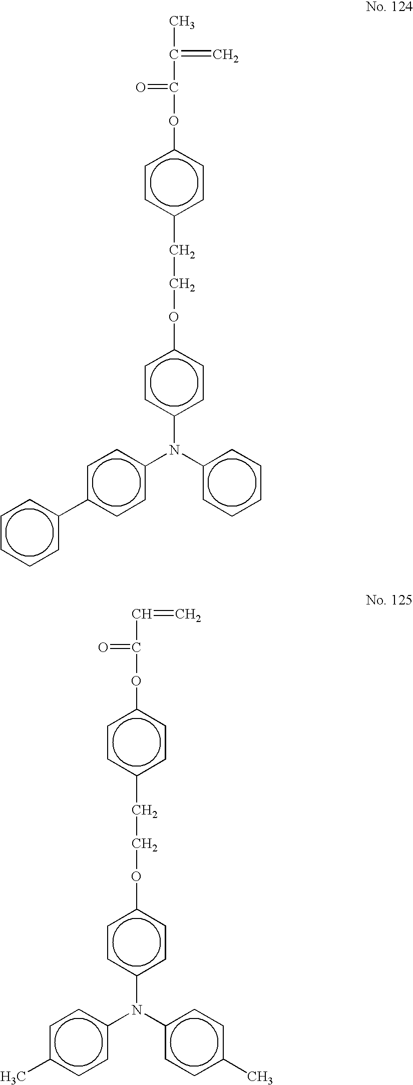

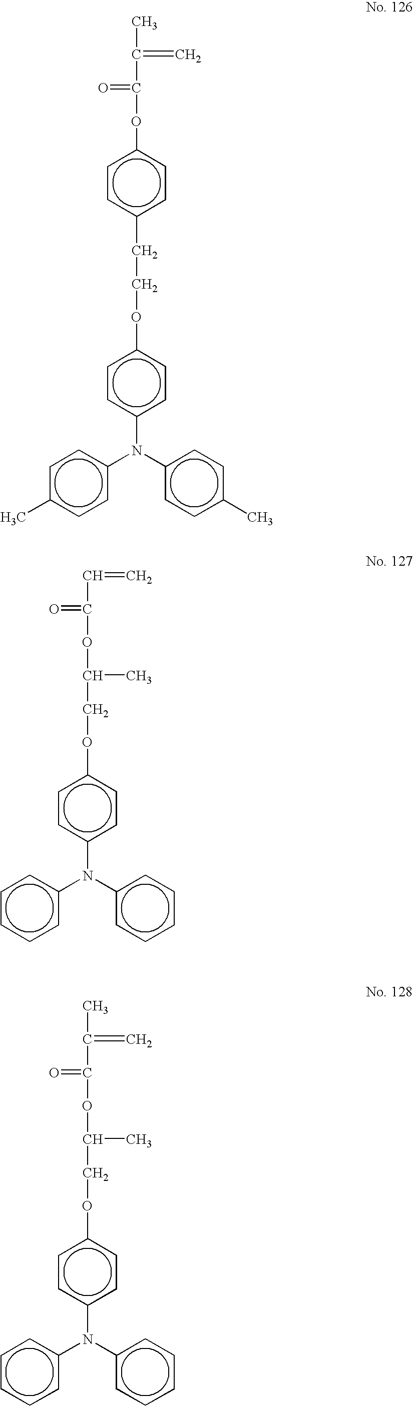

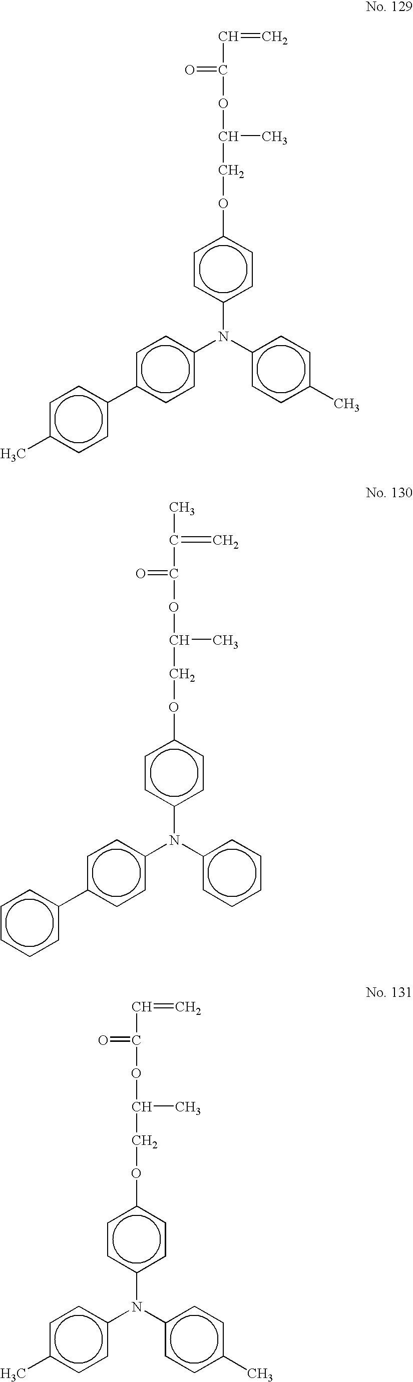

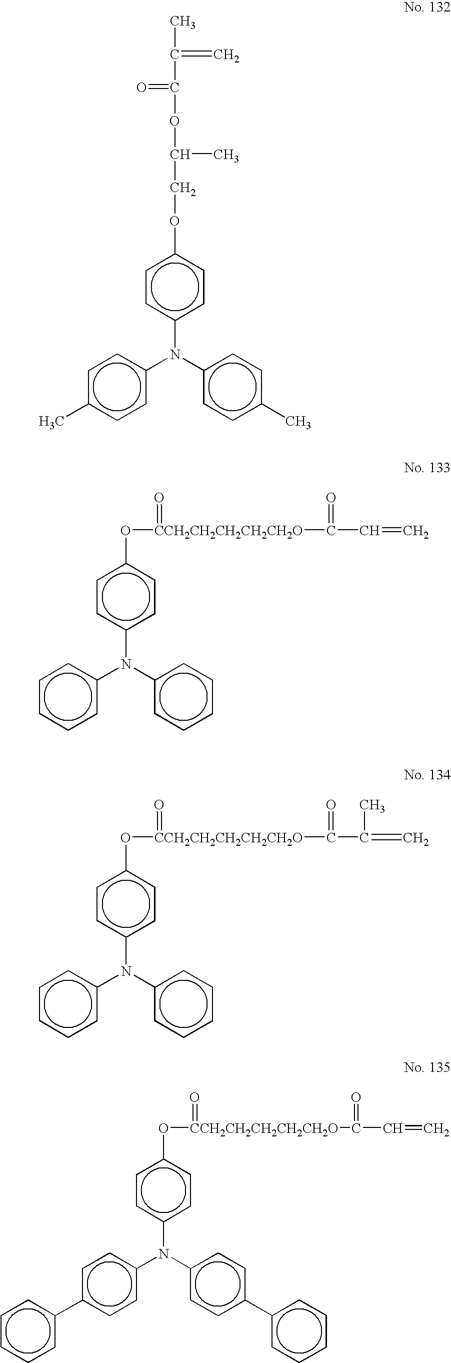

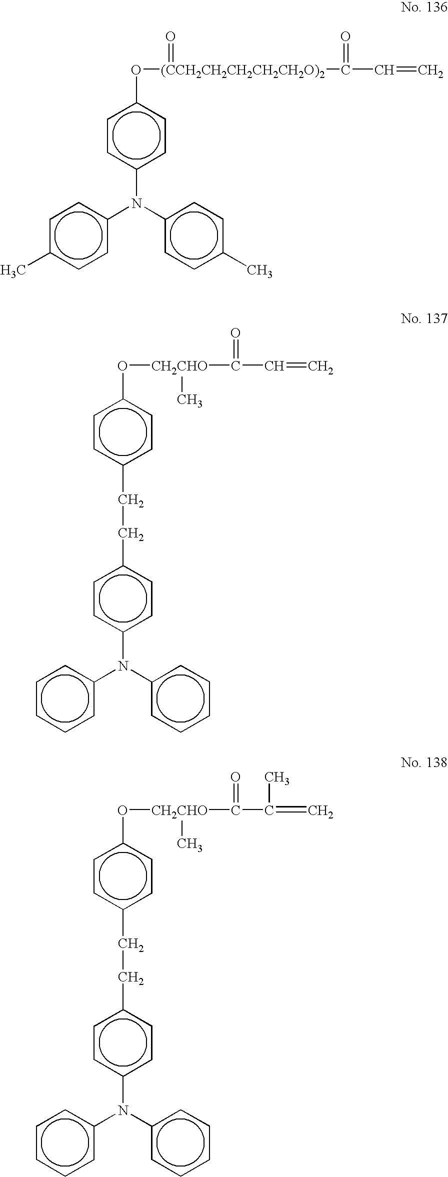

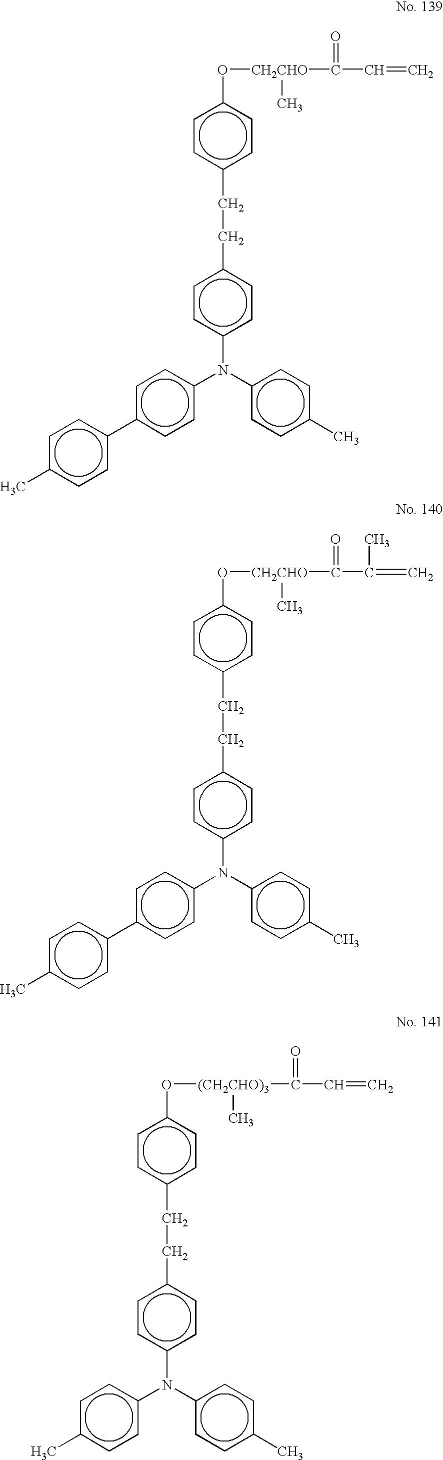

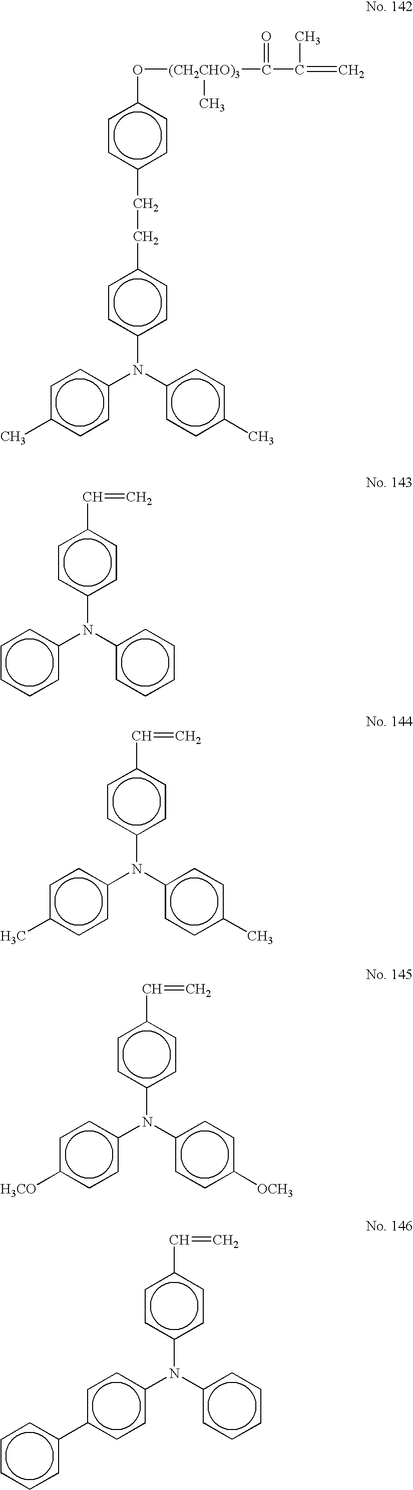

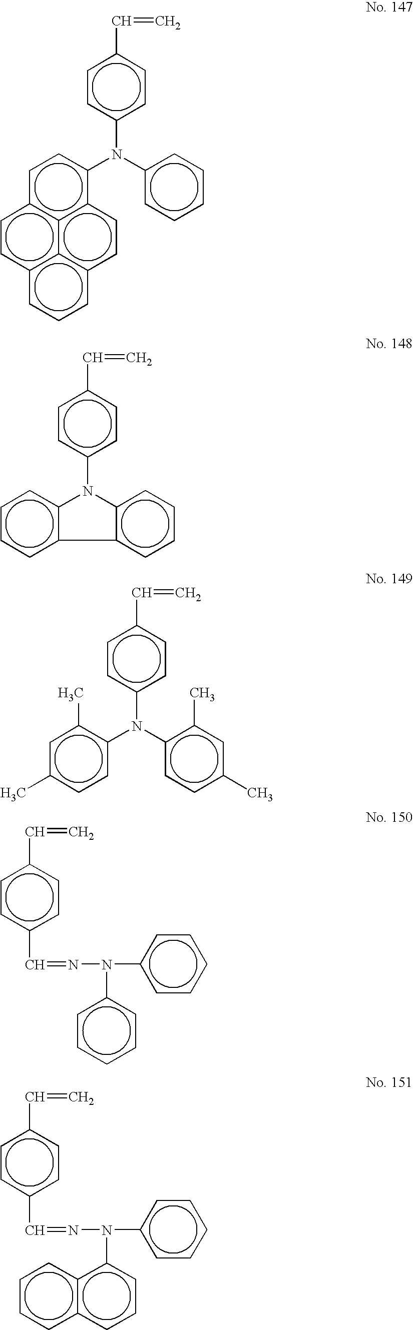

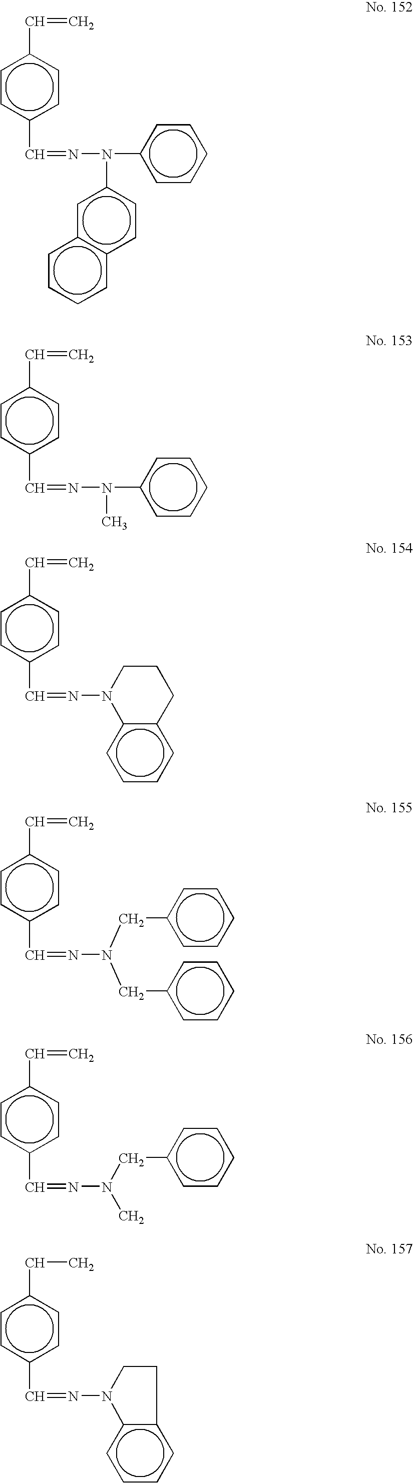

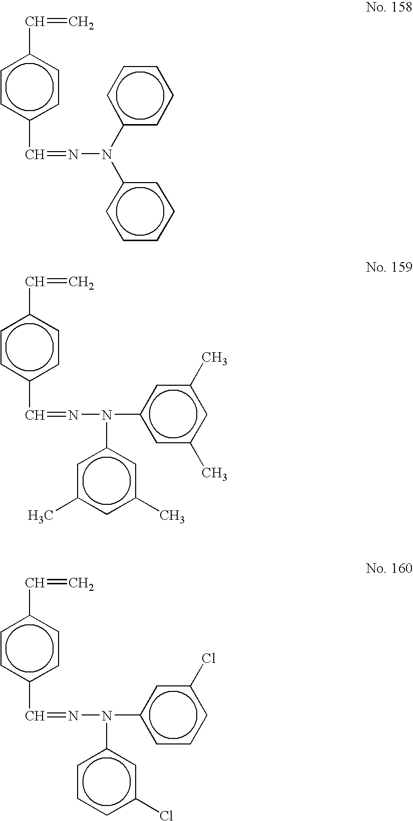

The radical polymerizable compound having one functionality and a charge transport structure employed in the present invention is essential for providing the crosslinked layer with charge transport ability. The content of the radical polymerizable compound is preferably 20% to 80% by mass, more preferably is 30% to 70% by mass, based on the total mass of the crosslinked layer. When the content is less than 20% by mass, the charge transport property of the crosslinked layer may not be sufficiently maintained, thus causing deterioration of electrical properties such as reduction of sensitivity and increase of residual potential under repeated usages. When the content of radical polymerizable compound having one functionality is more than 80% by mass, the content of the radical polymerizable monomer having three or more functionalities is inevitably deficient, thereby the crosslinked density is reduced and higher wear resistance may not be attained. The content of the radical polymerizable compound having one functionality is more preferably 30 to 70% by mass from the viewpoint of wear resistance and electric properties.

The crosslinked layer adapted to the present invention is formed by curing at least a radical polymerizable monomer having three or more functionalities and no charge transport structure and a radical polymerizable compound having one functionality and a charge transport structure. Additionally, in order to control viscosity during coating, to relieve stress of the crosslinked surface layer, to lower the surface energy, and/or to reduce the friction coefficient, a radical polymerizable monomer, functional monomer, and/or radical polymerizable oligomer having one or two functionalities may be combined together with, which are available from conventional substances.

Examples of the radical polymerizable compounds having one functionality include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isotearyl acrylate, stearyl acrylate, styrenemonomer and the like.

Examples of the radical polymerizable monomer having two functionalities include 1,3-butanediol diacrylate, 1,4-butanediol diacrylate, 1,4-butanediol dimethacrylate, 1,6-hexanediol diacrylate, 1,6-hexanediol dimethacrylate, diethyleneglycol diacrylate, neopentylglycol diacrylate, EO-modified bisphenol A diacrylate, EO-modified bisphenol F diacrylate, neopentylglycoldiacrylate and the like.

Examples of the functional monomer include fluorinated monomers such as octafluoropentylacrylate, 2-perfluorooctylethyl acrylate, 2-perfluorooctylethyl methacrylate, 2-perfluoroisononylethyl acrylate and the like; vinyl monomers, acrylate and methacrylate having a polysiloxane group such as acryloylpolydimethylsiloxaneethyl, methacryloylpolydimethylsiloxaneethyl, acryloylpolydimethylsiloxanepropyl, acryloylpolydimethylsiloxanebutyl, diacryloylpolydimethylsiloxanediethyl and the like, which have 20 to 70 siloxane repeating units, as described in Japanese Patent Application Publication (JP-B) Nos. 5-60503 and 6-45770.

Examples of the radical polymerizable oligomer include epoxy acrylates, urethane acrylates, and polyester acrylate oligomers. When the radical polymerizable monomer and/or radical polymerizable oligomer having one or two functionalities is added in an excessively large amount, three dimensional crosslink density of the crosslinked layer is likely to be lower, causing reduction of abrasion resistance. Preferably, the amount of these monomers or oligomer is 50 parts by mass or less, preferably 30 parts by mass or less, based on 100 parts by mass of the radical polymerizable monomer having three or more functionalities.

The photopolymerization initiator and the thermal polymerization initiator for curing the radical polymerizable monomer and the radical polymerizable monomer will be explained in the following.

Examples of the thermal polymerization initiator include peroxides such as methylethylketone peroxide, methylisobutylketone peroxide, acetylacetone peroxide, methylcyclohexanone peroxide, cyclohexanone peroxide, isobutylyl peroxide, 2,4-dichlorobenzoyl peroxide, bis-3,5,5-trimethylhexanoyl peroxide, lauroyl peroxide, benzoyl peroxide, p-chlorobenzoyl peroxide, diqumyl peroxide, 2,5-dimethyl-2,5-(t-butyloxy)hexane, 1,3-bis(t-butylperoxy-isopropyl)benzene, t-butylqumyl peroxide, di-t-butyl peroxide, 2,5-dimethyl-2,5-(di-t-butylperoxy)hexane-3, tris-(t-butylperoxy)triazine, 1,1-di-t-butylperoxy-3,3,5-trimethylcyclohexane, 1,1-di-t-butylperoxycyclohexane, 2,2-di(t-butylperoxy)butane, 4,4-di-t-butylperoxyvaleric acid n-butylester, 2,2-bis(4,4-t-butylperoxycyclohexyl)propane, t-butylperoxy isobutyrate, di-t-butylperoxy hexahydroterephthalate, t-butylperoxy-3,5,5-trimethylhexanoate, t-butylperoxybenzoate, di-t-butylperoxytrimethyladipate, and azo compounds such as azobis isobutyronitrile, azobisdimethyl valeronitrile, and azobiscyclohexyl nitrile.

Examples of the photopolymerization initiator include acetophenone or ketal compounds such as diethoxyacetophenone, 2,2-dimethoxy-1,2-diphenylethan-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1, 2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoinether compounds such as benzoin, benzoinmethyl ether, benzoinethylether, benzoinisobutylether, and benzoinisopropyl ether; benzophenone compounds such as benzophenone, 4-hydroxybenzophenone, methyl o-benzoylbenzoate, 2-benzoylnaphthalene, 4-benzoylbiphenyl, 4-benzoylphenylether, acrylated benzophenone, and 1,4-benzoylbenzene; thioxanthone compounds such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methylphenylglyoxyester, 9,10-phenanthrene compounds, acridine compounds, triazine compounds, imidazole compounds and the like.

Also, it is possible to employ a photopolymerization promoter together with the photopolymerization initiator described above; examples of the photopolymerization promoter include triethanolamine, methyldiethanolamine, ethyl 4-dimethylaminobenzoate, isoamyl 4-dimethylaminobenzoate, (2-dimethylamino)ethylbenzoate, 4,4′-dimethylaminobenzop henone and the like.

The polymerization initiators may be used alone or in combination. The total amount of the polymerization initiator is preferably 0.5 to 40 parts by mass, more preferably is 1 to 20 parts by mass based on 100 parts by mass of the total amount of the entire compounds capable of radically polymerizing. Preferably, the 10 hour half-life temperature of the thermal polymerization initiator is above 50° C., more preferably is 80° C. or more. When the 10 hour half-life temperature is 50° C. or less, the coating liquid is possibly poor in can-stability and tends to be easily hardened.

The coating liquid for the crosslinked layer in the present invention may contain various additives such as plasticizers for the purpose of relieving stress and improving adhesion, leveling agents, non-reactive charge transport substances with a low molecular and the like, depending on requirements. These additives may be selected from conventional materials or substances. Plasticizers available in the present invention include those commonly used in conventional resins such as dibutylphthalate, dioctylphthalate and the like; the additive amount is preferably 20% by mass or less, more preferably is 10% by mass or less based on the total solid content of the coating liquid. Further, leveling agents available in the present invention include silicone oils such as dimethyl silicone oil, methylphenyl silicone oil and the like, and polymers or oligomers having a perfluoroalkyl group in a side chain; the additive amount of the leveling agent is preferably 3% by mass or less based on the total solid content of the coating liquid.

The crosslinked layer in the present invention may be prepared by applying a coating liquid comprising a radical polymerizable monomer having three or more functionalities and no charge transport structure and a radical polymerizable compound having one functionality and a charge transport structure, followed by curing the coating liquid. When the radical polymerizable monomer or compound is liquid, the coating liquid may be prepared by way of dissolving or dispersing the other ingredients into the liquid of the radical polymerizable monomer or compound; alternatively, a solvent may be utilized for dissolving or dispersing the ingredients. Examples of the solvent include alcohols such as methanol, ethanol, propanol, and butanol; ketones such as acetone, methylethylketone, methyl isobutylketone, and cyclohexanone; esters such as ethyl acetate and butyl acetate; ethers such as tetrahydrofuran, dioxane, and propylether; halogenated compounds such as dichloromethane, dichloroethane, tolly chloroethane, and chlorobenzene; aromatics such as benzene, toluene, and xylene; cellosolves such as methylcellosolve, ethylcellosolve, and cellosolve. These solvents may be used alone or in combination. The dilution rate by the solvent depends on solubility of coating liquid, coating process, desired membrane thickness, and the like, and may be properly selected depending on the application. The coating may be applied by dipping, spraying, bead coating, ring coating, or the like.

In the present invention, after the coating liquid is applied, the coating is cured by exposing to external energy thereby to form a crosslinked layer. The external energy may be thermal, optical, or radiation energy. The thermal energy may be applied by heating the coating or support by use of air, nitrogen, vapor, or various heating media, infrared ray, or electronic wave. The heating temperature is preferably 80 to 170° C. When the temperature is less than 80° C., the reaction rate is slower and the reaction may not progress sufficiently. When the temperature is higher than 170° C., the reaction may progress nonuniformly, possibly causing significant distortion in the crosslinked layer. In some cases, preferably; initial heating is carried out at a lower temperature of 50° C. or less, then further heating is carried out at a higher temperature of 100° C. or higher. The source of optical energy may be selected from high pressure mercury lamps and metal halide lamps having an main emitting wavelength at UV region, and also visible light sources in accordance with the absorption wave length of the radical polymerizable components or photopolymerization initiators. The irradiated energy is preferably 50 to 1000 mW/cm². When the irradiated energy is less than 50 mW/cm², the curing period is often excessively long, and when it is more than 1000 mW/cm², the surface of the crosslinked layer is likely to be considerably rough due to nonuniform reaction. Example of radiation energy may be of electron beam. Among the energies, thermal and optical energy may be effective and useful by virtue of easiness of controlling the reaction rate and convenience of the apparatus.

To the raw material of the crosslinked layer containing the photopolymerization initiator and the thermal polymerization initiator, any one of optical energy and thermal energy may be applied initially. When the optical energy is applied by means of a high pressure mercury lamp, the irradiated material may be heated to 80° C. or more, thereby promoting efficiently the thermal polymerization.

The thickness of the crosslinked layer depends on the layer structure of the photoconductor; the thickness will be explained later along with the layer structure.

In order to attain superior surface smoothness of the crosslinked layer, it is desirable that the crosslinked layer is cured uniformly, and such uniform curing can be achieved by combining the photopolymerization and the thermal polymerization.

It has been experienced that inferior surface smoothness tends to generate background smear or streak due to inferior cleaning, or image flow or thickening of letters under higher humidity atmosphere. In order to enhance the surface smoothness of crosslinked layers, it is desirable that curing rates are uniform and polymerization progresses consistently. Particularly, partial polymerization at initial stage often leads to nonuniformities of volume shrinkage, resulting in tensile stress at sites where polymerization being slower and thus uneven surface as a whole. These nonuniformities are more significant as the layer thickness increases.

These nonuniformities may be reduced and the surface smoothness may be enhanced by way of mitigating the curing or polymerization. However, lowered surface hardness results in more significant wear. Further, radical polymerizable compounds having two or more functionalities and a charge transport structure and/or binder resins may enhance the surface smoothness of the photoconductor surface. However, the incorporation of radical polymerizable compounds having two or more functionalities typically generates internal stress at polymerization reaction and lead to surface irregularity due to the bulky charge transport structure. Further, when polymer materials such as binder resins are incorporated into the coating liquid, phase separation is likely to be induced due to less compatibility with polymers produced from the radical polymerizable monomer and the radical polymerizable compound, resulting in remarkable irregularity of photoconductor surface. Accordingly, it is preferred that radical polymerizable compounds having two or more functionalities and a charge transport structure and binder resins are not incorporated.

The crosslinked layer in the present invention is required that bulky charge transport structure is incorporated into the crosslinked layer so as to maintain the electric properties and the crosslink density is enhanced so as to increase the mechanical strength. In the process to cure the surface layer after coating, when the reaction is promoted rapidly by sufficiently supplying external energy, the curing reaction progresses unevenly and the surface irregularity of crosslinked layer turns into significant. Accordingly, it is preferred that external energy such as thermal energy and optical energy is employed that can control the reaction rate by the factors such as heating conditions, irradiating quantities, and amount of polymerization initiators.

As for solvents for the coating liquid, when a plenty amount of solvent capable of dissolving the underlayer is incorporated into the coating liquid, the components such as the resin binder and charge transport substance may infiltrate into the crosslinked layer; as a result, the curing reaction may be inhibited, and also the surface of the crosslinked layer may turn into irregular similarly as a condition that a plenty of non-curable material is incorporated into the coating liquid previously. On the other hand, when a solvent is employed that cannot dissolve the underlayer at all, the adhesion is likely to be poor between the crosslinked layer and the underlayer, and the surface may be significantly rough due to crater-like repellency at the crosslinked layer derived from volume shrinkage during the curing reaction. In order to address these problems, various improvements are recommended such that a mixed solvent is employed as the solvent to control the solubility for the underlayer, the amount of solvent is reduced by arranging the composition of coating liquid or modifying the coating process, the inclusion of the underlayer components is decreased by employing a charge transport polymer into the underlayer, and an intermediate layer with lower solubility or higher adhesive ability is provided between the underlayer and the crosslinked layer.

The way to make smooth the crosslinked layer will be exemplified. When an acrylate monomer having three acryloyloxy groups and a triaryl amine compound having one acryloyloxy group are utilized, preferably, the ratio of the amount is 7:3 to 3:7. A photopolymerization initiator and a thermal polymerization initiator are combined and added in an amount of 3 to 20% by mass based on the total amount of the acrylate compound, and a solvent is added to prepare a coating liquid. For example, when triaryl amine is utilized as the charge transport substance and polycarbonate is utilized as the binder resin, and the surface layer is coated through spraying method, the solvent of the coating liquid is preferably tetrahydrofuran, 2-butane, or ethyl acetate, and the amount of the solvent is 3 to 10 times the entire acrylate compound.

Then, an undercoat layer, charge generating layer, and charge transport layer are coated on the support of alumina cylinder, then the coating liquid of the crosslinked charge transport layer is applied by spraying etc. on the charge transport layer. Then, the coating is subjected to drying at lower temperatures for shorter period, e.g. 25 to 85° C. for 1 to 10 minutes, thereafter is hardened through photopolymerization under ultraviolet (UV) irradiation and then is hardened through thermal polymerization so as to cure the coating uniformly.

In UV irradiation, preferably, a metal halide lamp etc. is used at an irradiated energy of 50 mW/cm² to 1000 mW/cm². For example, when UV irradiation is applied at 500 mW/cm², the irradiation is preferably applied from various directions for about 20 seconds. The temperature of the photoconductor is to be controlled so as not to exceed 50° C. When the crosslinked layer is cured through thermal polymerization, the heating temperature is preferably 100 to 170° C. When a forced-air oven is used as the heater and the heating temperature is set to 150° C., the heating time is preferably about 20 minutes to about 3 hours, for example.

<Layer Structure of Photoconductor>

The photoconductor in the present invention will be explained with reference to drawings.

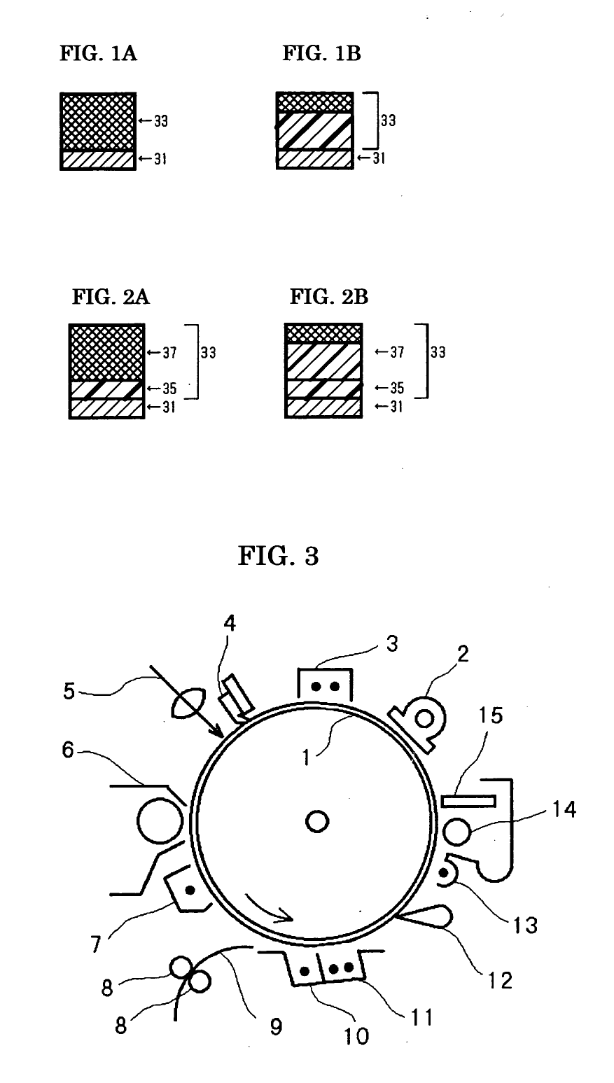

FIG. 1A shows an exemplary single-layered photoconductor, in which photosensitive layer 33 with charge generating property as well as charge transport property is provided on support 31 and the crosslinked layer occupies the photosensitive layer entirely. FIG. 1B shows an exemplary single-layered photoconductor, in which the crosslinked layer is the surface portion of the photosensitive layer.

FIG. 2A shows an exemplary photoconductor containing laminated layers, in which charge generating layer 35 with charge generating property and charge transport layer with charge transport property are laminated on support 31 and the crosslinked layer occupies the charge transport layer entirely. FIG. 2B schematically shows an exemplary photoconductor containing laminated layers, in which the crosslinked layer is the surface portion of the charge transport layer.

In FIGS. 1A to 2B, each of the crosshatched regions indicates a crosslinked surface region.

<Support>

The support 31 may be a film-shaped or cylindrically-shaped plastic or paper covered with a conducting material having a volume resistivity of 10¹⁰ ohm·cm or less, for example, metals such as aluminum, nickel, chromium, nichrome, copper, gold, silver, and platinum, metal oxides such as tin oxide and indium oxide, by vapor deposition or sputtering; alternatively support 31 may be a plate of aluminum, aluminum alloy, nickel or stainless steel, or may be formed into a tube by extrusion or drawing, cut, polished and surface-treated. The endless nickel belt and endless stainless steel belt such as those illustrated in JP-A No. 52-36016 may also be employed as the conductive support 31.

Further, the support 31 may be prepared by way of blending conductive fine particles and a suitable binder resin and coating them onto a support material. Examples of the conductive fine particles include carbon black such as acetylene black, metal power fine particles such as of aluminum, nickel, iron, nichrome, copper, zinc and silver, and metal oxide fine particles such as of conductive tin oxide and ITO. As for the binder resin which is used together with the conductive fine particles, the following resin may utilized: polystyrene, styrene acrylonitrile copolymer, styrene butadiene copolymer, styrene maleic anhydride copolymer, polyester, polyvinyl chloride, vinyl chloride vinyl acetate copolymer, polyvinyl acetate, polyvinylidene chloride, polyacrylate resin, phenoxy resin, polycarbonate, cellulose acetate resin, ethyl-cellulose resin, polyvinyl butyral, polyvinyl formal, polyvinyl toluene, poly-N-vinylcarbazole, acrylate resin, silicone resin, epoxy resin, melamine resin, urethane resin, phenol resin, alkyd resin, etc.

The conductive layer can be prepared by dispersing and coating the conductive fine particles and the binder resin to a suitable solvent, for example, tetrahydrofuran, dichloromethane, methyl ethyl ketone, toluene, etc.

Further, the conductive support which is prepared by forming the conductive layer on a suitable cylinder base with a thermal-contraction inner tube which is made of a suitable material, such as polyvinyl chloride, polypropylene, polyester, polystyrene, polyvinylidene chloride, polyethylene, chlorinated rubber, Teflon™ etc. and contain the conductive fine particles may also be utilized as the support 31 in the present invention.

<Photosensitive Layer>

The photosensitive layer will be explained in the following. The photosensitive layer may be of laminated structure or single-layered structure.

When the photosensitive layer is of laminated structure, the photosensitive layer comprises a charge generating layer and a charge transport layer. Namely, in a preferable construction, the photosensitive layer represents a laminated structure that comprises the support, a charge generating layer, and a charge transport layer in this order, and the crosslinked layer is the surface layer of the photosensitive layer. When the photosensitive layer is of single-layered structure, the photosensitive layer is a layer having both charge generating property and charge transport property.

The photosensitive layers will be explained more specifically in terms of those having a laminated structure and a single-layered structure respectively.

<Photosensitive Layer with Charge Generating and Charge Transport Layers>

(Charge Generating Layer)

The charge generating layer 35 is a layer comprising mainly a charge generating material having charge generating property and may be used in combination with a binder resin as needed. The charge generating materials may be classified into inorganic materials and organic materials.

Examples of inorganic materials include crystalline selenium, amorphous selenium, selenium-tellurium, selenium-tellurium-halogen, selenium-arsenic compound, and amorphous silicon. The amorphous silicon may have dangling bonds terminated with a hydrogen atom or halogen atom, or it may be doped with boron or phosphorus.

The organic material may be selected from conventional materials, examples thereof include phthalocyanine pigments such as metal phthalocyanine, non-metal phthalocyanine and the like, azulenium salt pigments, squaric acid methine pigment, azo pigments having a carbazole skeleton, azo pigments having a triphenylamine skeleton, azo pigments having a diphenylamine skeleton, dibenzothiophene skeleton, azo pigments having a fluorenone skeleton, azo pigments having a oxadiazole skeleton, azo pigments having a bisstylbene skeleton, azo pigments having a distyryoxide azole skeleton, azo pigments having a distyrylcarbazole skeleton, pherylene pigments, anthraquinone or polycyclic quinone pigments, quinone imine pigments, diphenylmethane and triphenylmethane pigments, benzoquinone and haphtoquinone pigments, cyanine and azomethine pigments, indigoido pigments, bisbenzimidazole pigments and the like. These charge generating materials may be used alone or in combination.

Examples of the binder resins appropriate for the charge generating layer 35 include polyamides, polyurethanes, epoxy resins, polyketones, polycarbonates, silicone resins, acrylic resins, polyvinyl butyrals, polyvinyl formals, polyvinyl ketones, polystyrene s, poly-N-vinyl carbazole s, and polyacrylamide s. These binder resins may be used alone or in combination. In addition to the binder resin as described above, the binder resins utilized with the charge generating layer may be selected from charge transport polymers, for example, polycarbonates, polyesters, polyurethanes, polyethers, polysiloxanes, and acrylic resins which have an arylamine skeleton, benzidine skeleton, hydrazone skeleton, carbazole skeleton, stylbene skeleton, pyrazoline skeleton or the like, or polymers having a polysilane skeleton.

Specific examples of the charge transport polymer are illustrated in JP-A No. 01-001728, JP-A No. 01-009964, JP-A No. 01-013061, JP-A No. 01-019049, JP-A No. 01-241559, JP-A No. 04-011627, JP-A No. 04-175337, JP-A No. 04-183719, JP-A No. 04-225014, JP-A No. 04-230767, JP-A No. 04-320420, JP-A No. 05-232727, JP-A No. 05-310904, JP-A No. 06-234836, JP-A No. 06-234837, JP-A No. 06-234838, JP-A No. 06-234839, JP-A No. 06-234840, JP-A No. 06-234841, JP-A No. 06-239049, JP-A No. 06-236050, JP-A No. 06-236051, JP-A No. 06-295077, JP-A No. 07-056374, JP-A No. 08-176293, JP-A No. 08-208820, JP-A No. 08-211640, and JP-A No. 08-253568. The polycarbonate resins having a triarylamine structure at the main chain or side chain are illustrated in JP-A No. 08-269183, JP-A No. 09-062019, JP-A No. 09-043883, JP-A No. 09-71642, JP-A No. 09-87376, JP-A No. 09-104746, JP-A No. 09-110974, JP-A No. 09-110976, JP-A No. 09-157378, JP-A No. 09-221544, JP-A No. 09-227669, JP-A No. 09-235367, JP-A No. 09-241369, JP-A No. 09-268226, JP-A No. 09-272735, JP-A No. 09-302084, JP-A No. 09-302085, JP-A No. 09-328539 and the like.

Specific examples of the polymers having a polysilane skeleton described above are polysilylene polymers illustrated in JP-A No. 63-285552, JP-A No. 05-19497, JP-A No. 05-70595 and JP-A No. 10-73944.

Further, a charge transport substance having a lower molecular mass may be incorporated into charge generating layer 35. The charge transport substances are classified into hole transport substances and electron transport substances. Examples of the electron transport substance include chloroanil, bromoanil, tetracyanoethylene, tetracyano quinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indino[1,2-b]thiophene-4-on, 1,3,7-trinitro-dibenzothiophene-5,5-dioxide, and diphenoquinone derivatives. These electron transport substances may be used alone or in combination.

Examples of the hole transporting substance include oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, and the like. These hole transporting substances may be used alone or in combination.

In general, the charge generating layer 35 may be formed by way of film forming processes under a vacuum atmosphere or casting processes by use of a solution or dispersion.

The former processes include the vacuum deposition, glow discharge electrolysis, ion plating, sputtering, reactive-sputtering, and CVD processes, which may form satisfactory inorganic materials or organic materials.

In order to provide the charge generating layer by the casting process, an inorganic or organic charge-generating material is dispersed, together with a binder resin as required, by a ball mill, attritor, sand mill, or bead mill using an organic solvent such as tetrahydrofuran, dioxane, dioxolane, toluene, dichloromethane, monochlorobenzene, dichloroethane, cyclohexanone, cyclopentanone, anisole, xylene, methyl ethyl ketone, acetone, ethyl acetate, or butyl acetate, thereby properly diluting the dispersion liquid, and applying the dispersion liquid as a coating. A leveling agent such as dimethyl silicone oil, methylphenyl silicone oil and the like may be added to the dispersion liquid as required. The dispersion liquid may be applied by way of dip coating, spray coating, bead coating, ring coating and the like.

Preferably, the thickness of the charge generating layer is 0.01 to 5 μm, more preferably is 0.05 to 2 μm.

(Charge Transport Layer)

The charge transport layer 37 exhibits charge transport property, and the crosslinked layer having a charge transport structure in the present invention may be effectively utilized as the charge transport layer. When the crosslinked layer is the entire charge transport layer 37, a coating liquid containing the radical polymerizable monomer having three or more functionalities and no charge transport structure and the radical polymerizable compound having one functionality and a charge transport structure (hereinafter, referring to as “radical polymerizable composition” in the present invention) is applied on the charge generating layer 35, followed by drying as required, and cured by use of external energy thereby to form the crosslinked layer. Preferably, the thickness of the crosslinked layer is 10 to 30 μm, more preferably is 10 to 25 μm. When the thickness is thinner than 10 μm, the charging potential may not be maintained, and when the thickness is above 30 μm, the crosslinked layer may separate from the underlayer owing to volume contraction upon curing.

When the charge transport layer 37 has a laminated structure comprising the crosslinked layer formed on the charge transport layer 37, the undercoat layer of the charge transport layer may be formed by way of dissolving or dispersing a charge transport substance and a binder resin in a proper solvent and applying the resulting liquid on the charge generating layer 35, followed by drying, then the coating liquid containing the “radical polymerizable composition” in the present invention is applied and cross-linked by use of the external energy as described above.

As for charge transport substance, the electron transport substances, hole transport substances, and charge transport polymers described above may be employed. In particular, the charge transport polymers, more particularly, polycarbonates having a triarylamine structure at the main chain or side chain is favorable since solubility of the undercoat layer may be suppressed upon coating of the surface layer.

Examples of the binder resin include polystyrene, styrene-acrylonitrile copolymers, styrene-butadiene copolymers, styrene-maleicanhydride copolymers, polyester, polyvinyl chloride, vinylchloride-vinylacetate copolymers, polyvinyl acetate, polyvinylidene chloride, polyacrylate resins, phenoxy resins, polycarbonates, celluloseacetate resins, ethyl-cellulose resins, polyvinyl butyral, polyvinyl formal, polyvinyl toluene, poly-N-vinylcarbazole, acrylate resins, silicone resins, epoxy resins, melamine resins, urethane resins, phenol resins, alkyd resins, and the like.

The amount of the charge transport substance is preferably 20 to 300 parts by mass, more preferably is 40 to 150 parts by mass based on 100 parts by mass of the binder resin. When the charge transport substance is a polymer, the charge transport substance may be employed without the binder resin.

The solvents utilized with the charge transport layer may be the same as those in terms of the charge generating layer described above. Preferably, the solvents can dissolve both of the charge transport substance and the binder resin. The charge transport layer may be coated in the similar way as the charge generating layer 35.

The charge transport layer may include additives such as plasticizers and leveling agents depending on requirements. Specific examples of the plasticizers include known ones, which are used for plasticizing resins, such as dibutyl phthalate, dioctyl phthalate and the like. The additive amount of the plasticizer is 0 to 30 parts by mass based on 100 parts by mass of the binder resin. Specific examples of the leveling agents include silicone oils such as dimethyl silicone oil, and methyl phenyl silicone oil; polymers or oligomers including a perfluoroalkyl group in their side chain, and the like. The additive amount of the leveling agents is 0 to 1 part by mass based on 100 parts by mass of the binder resin.

The underlayer of the charge transport layer is preferably 5 to 40 μm thick, more preferably is 10 to 30 μm thick.

When the crosslinked layer is the surface part of the charge transport layer 37, as described for the process for forming the crosslinked layer, a coating liquid containing the radical polymerizable composition in the present invention is applied on the undercoat layer part of the charge transport layer, followed by drying as needed, and subjected to the curing reaction by use of external energy such as thermal energy and optical energy thereby to form the crosslinked layer. Preferably, the crosslinked layer is 1 to 20 μm, more preferably is 2 to 10 μm. When the thickness is less than 1 μm, the durability may fluctuate remarkably depending on the deviation of the thickness, and when the thickness exceeds 20 μm, the image reproducibility may be deteriorated due to charge diffusion throughout the entire layer.

<Single-Layered Photosensitive Layer>

A photosensitive layer having a single-layered structure refers to a layer having both charge generating property and charge transport property; the crosslinked layer containing a charge transport structure in the present invention may be favorably employed as the photosensitive layer having a single-layered structure by including a charge generating substance. As described in the casting process of the charge generating layer, a charge generating substance is dispersed into a coating liquid containing a radical polymerizable composition, applied on conductive support 31, followed by drying as needed, and subjected to the curing reaction by use of external energy to form a crosslinked layer. The charge generating substance, being dispersed previously in a solvent, may be added to the coating liquid for the crosslinked layer. Preferably, the crosslinked layer is 10 to 30 μm thick, more preferably is 10 to 25 μm. When the thickness is less than 10 μm, it is impossible to maintain a sufficient charge potential, and while it exceeds 30 μm, generation of conductive gases or separation of undercoating layer may occur owing to volume contraction upon curing.

Also, when the crosslinked layer is a surface part having a single-layered structure of the photosensitive layer, the undercoat layer of the photosensitive layer is formed by dissolving or dispersing a charge generating substance, a charge transport substance, and a binder resin in a proper solvent and applying it, followed by drying. Also, a plasticizer, a leveling agent and the like may be added as needed. The dispersion process of the charge generating substance, the charge generating substance, the charge transport substance, the plasticizer, and the leveling agent may be the same as described in terms of the charge generating layer 35 and the charge transport layer 37. As for the binder resin, in addition to the binder resins described for the charge transport layer 37, the binder resins described for the charge generating layer 35 may be employed in combination. Also, the charge transport polymer may be used, which is favorable in reducing the inclusion of the photosensitive composition of the lower layer into the crosslinked layer. Preferably, the undercoat layer of the photosensitive layer is 5 to 30 μm thick, more preferably is 10 to 25 μm thick.

When the surface part of the photosensitive layer is the crosslinked layer having a single-layered structure, the crosslinked layer is formed by way of applying a coating liquid containing the radical polymerizable composition and a charge generating substance on the undercoat layer part of the photosensitive layer, followed by drying as needed, and curing the coating by use of external energy of thermal energy and optical energy, as described above. Preferably, the crosslinked layer has a thickness of 1 to 20 μm, more preferably 2 to 10 μm. When the thickness is less than 1 μm, the durability may fluctuate owing to the deviation of the thickness.

The charge generating substance contained in the photosensitive layer having a single-layered structure is preferably 1 to 30% by mass, the binder resin contained in the photosensitive layer is preferably 20 to 80% by mass, and the charge transport substance contained in the photosensitive layer is preferably 10 to 70% by mass, based on the total amount of the photosensitive layer respectively.

<Intermediate Layer>

In the photoconductor according to the present invention, when the crosslinked layer is the surface part of the photosensitive layer, an intermediate layer may be provided to inhibit inclusion of the underlayer components into the crosslinked layer or to improve the adhesion with the underlayer.

A binder resin is typically employed as the main component of the intermediate layer. Examples of these resins are polyamides, alcohol-soluble nylon, water-soluble polyvinyl butyral, polyvinyl butyral, and polyvinyl alcohol. Conventional coating processes may be carried out in order to form the intermediate layer, as described above. The thickness of the intermediate layer is preferably 0.05 to 2 μm.

<Undercoat Layer>

In the photoconductor of the present invention, an undercoat layer may be provided between conductive support 31 and the photosensitive layer. The undercoat layer is typically formed of resins. The resins are preferably solvent-resistant against common solvents since the photosensitive layer containing an organic solvent is usually coated on the undercoat layer. Examples of the resin include water-soluble resins such as polyvinyl alcohol, casein, sodium polyacrylate, alcohol-soluble resins such as copolymer nylon and methoxymethylated nylon, and curing resins which form a three-dimensional network such as polyurethane, melamine resins, phenol resins, alkyd-melamine resins, and epoxy resins.

Also, metal oxide fine powder pigments such as titanium oxide, silica, alumina, zirconium oxide, tin oxide or indium oxide may be added to the undercoat layer to prevent Moire patterns, and to reduce residual potential. Among these, titanium oxide is most preferable from the viewpoint of decrease of residual potential, prevention of Moire patterns, and suppression of background smear.

These undercoat layer may be formed using a suitable solvent and by way of a coating method as described in terms of the charge transport layer. A silane coupling agent, titanium coupling agent or chromium coupling agent, etc. can be used as the undercoat layer of the present invention. Also, Al₂O₃ prepared by anodic oxidation, organic materials such as polyparaxylylene (parylene) and inorganic materials such as SiO₂, SnO₂, TiO₂, ITO, CeO₂ prepared by the vacuum thin film-forming process, can be used for the undercoat layer. The thickness of the undercoat layer is preferably 0 to 5 μm.

<Anti-Oxidant>

In the present invention, anti-oxidants may be incorporated into the respective layers of crosslinked surface layer, photosensitive layer, charge generating layer, charge transport layer, undercoat layer, intermediate layer etc. in order to improve the environmental resistance, in particular to prevent the sensitivity decrease and the residual potential increase.

The anti-oxidant available for the respective layers may be exemplified as follows, but not limited to.

(i) Phenol Compounds:

2,6-di-t-butyl-p-cresol, butylhydroxyanisole,
2,6-di-t-butyl-4-ethylphenol,
stearyl-β-(3,5-di-t-butyl-4-hydroxyphenyl)propionate,
2,2′-methylene-bis-(4-methyl-6-t-butylphenol),
2,2′-methylene-bis-(4-ethyl-6-t-butylphenol),
4,4′-thiobis-(3-methyl-6-t)-butylphenol,
4,4′-butylydenebis-(3-methyl-6-t-butylphenol),
1,1,3-tris-(2-methyl-4-hydroxy 5-t-butylphenyl)butane,
1,3,5-trimethyl-2,4,6-tris-(3,5-di-t-butyl-4-hydroxybenzyl)benzene,
tetrakis-[methylene 3-(3′,5′-di-t-butyl-4′-hydroxy-phenyl)propionate]methane,
bis-[3,3′-bis-(4′-hydroxy-3′-t-butylphenyl)butylic acid]glycolester, tocopherols, etc,
   (ii) Paraphenylene Diamine Compounds:
N-phenyl-N′-isopropyl-p-phenylene diamine,
N,N′-di-sec-butyl-p-phenylene diamine,
N-phenyl-N-sec-butyl-p-phenylene diamine,
N,N′-di-isopropyl-p-phenylene diamine,
N,N′-dimethyl-N,N′-di-t-butyl-p-phenylene diamine, etc,
   (iii) Hydroquinone Compounds:
2,5-di-t-octyl hydroquinone, 2,6-di-dodecyl hydroquinone, 2-dodecyl hydroquinone, 2-dodecyl 5-chlorohydroquinone, 2-t-octyl 5-methyl hydroquinone, 2-(2-octadecenyl)-5-methyl hydroquinone, etc,
   (iv) Organosulfur Compounds:
   dilauril-3,3′-thiodipropionate, distearil-3,3′-thiodipropionate, tetradecyl-3,3′-thiodipropionate, etc,
      (v) Organophosphorus Compounds:
   triphenyl phosphine, tri(nonylphenyl)phosphine, tri(di-nonyl phenyl) phosphine, tri-cresil phosphine, tri(2,4-dibutyl phenoxy)phosphine, etc,

These compounds are known as the anti-oxidants of rubber, plastic, fatty and oil, and are commercially available. The content of the anti-oxidant is preferably 0.01 to 10% by mass based on the total mass of the layer to be incorporated.

<Image Forming Process and Image Forming Apparatus>

The image forming apparatus according to the present invention comprises a photoconductor, latent electrostatic image forming unit, developing unit, transferring unit, and fixing unit, and may further comprise other units, for example, charge-eliminating unit, cleaning unit, recycling unit, and controlling unit, depending on requirements.

The image forming process according to the present invention comprises a latent electrostatic image forming step, developing step, transferring step, and fixing step, and may further comprise other steps, for example, charge-eliminating step, cleaning step, recycling step and controlling step, depending on requirements.

The photoconductors according to the present invention may be properly utilized in these units and steps.

The image forming process according to the present invention may be advantageously applied to the image forming apparatus according to the present invention. The latent electrostatic image forming step may be performed by the latent electrostatic image forming unit, the developing step may be performed by the developing unit, the transferring step may be performed by the transferring unit, and the fixing step may be performed by the fixing unit. The other units may perform the other steps.

Image Forming Step and Image Forming Unit

The latent electrostatic image forming step is one that forms a latent electrostatic image on the photoconductor. The photoconductor may be one according to the present invention.

The latent electrostatic image may be formed, for example, by uniformly charging the surface of the photoconductor, and irradiating it imagewise, which may be performed by the latent electrostatic image forming unit.

The latent electrostatic image forming unit, for example, comprises a charger which uniformly charges the surface of the photoconductor, and an irradiator which exposes the surface of the latent image carrier imagewise.

The charging may be performed, for example, by applying a voltage to the surface of the photoconductor using the charger.

The charger is may be properly selected depending on the application, for example, contact chargers known in the art such as a conductive or semi-conductive roller, brush, film or rubber blade, and non-contact chargers using corona discharge such as corotron and scorotron are exemplified.

The exposing may be performed by irradiating the surface of the photoconductor imagewise, using the irradiator for example.

The irradiator is may be properly selected depending on the application as long as capable of exposing the surface of the photoconductor charged by the charger in the same way as the image to be formed, for example, an irradiator such as copy optical system, rod lens array system, laser optical system, and liquid crystal shutter optical system may be exemplified.

In addition, in the present invention, a backlight system may be employed by which the photoconductor is exposed imagewise from its rear surface.

Developing Step and Developing Unit

The developing step is one that develops a latent electrostatic image using the toner supplied from the toner cartridge according to the present invention to form a visible image.

The visible image may be formed, for example, by developing the latent electrostatic image using the toner or developer, which may be performed by the developing unit.

The developing unit may be properly selected as long as capable of developing an image for example by using the toner or developer. Examples are those which comprise an image-developer housing the toner and which may supply the toner with contact or without contact to the latent electrostatic image.

In the image-developer, the toner and the carrier may, for example, be mixed and stirred together. The toner is thereby charged by friction, and forms a magnetic brush on the surface of the rotating magnet roller. Since the magnet roller is arranged near the photoconductor, a part of the toner in the magnetic brush formed on the surface of the magnet roller moves toward the surface of the photoconductor due to the force of electrical attraction. As a result, the latent electrostatic image is developed by use of the toner, and a visible toner image is formed on the surface of the photoconductor.

Transferring Step and Transferring Unit

The transferring step is one that transfers the visible image to a recording medium. In a preferable aspect, the first transferring is performed, wherein using an intermediate image-transfer member, the visible image is transferred to the intermediate image-transfer member, and the second transferring is then performed wherein the visible image is transferred to the recording medium. In a more preferable aspect, using toner of two or more colors and preferably full color toner, the primary transferring step transfers the visible image to the intermediate image-transfer member to form a compounded transfer image, and the second transferring step transfers the compounded transfer image onto the recording medium.

The transferring can be carried out, for example, by charging the photoconductor using a transferring charger, which can be performed by the transferring unit. In a preferable aspect, the transferring unit comprises a first transferring unit which transfers the visible image onto the intermediate image-transfer member to form a compound transfer image, and a second transferring unit which transfers the compounded transfer image onto the recording medium.

The intermediate image-transfer member may be properly selected from transfer materials or devices known in the art such as transfer belts.

The transferring unit of the first transferring unit and the second transferring unit preferably comprise an image-transferer which charges by releasing the visible image formed on the photoconductor or photoconductor to the recording-medium side. There may be one, two or more of the transferring unit.

The image-transferer may be a corona transferring unit based on corona discharge, transferring belt, transferring roller, pressure transferring roller, or adhesion transferring unit.

The recording medium may be properly selected from recording media or recording papers known in the art. The recording medium is typically plain paper, and also other materials such as polyethylene terephthalate (PET) sheets for overhead projector (OHP) may be utilized.

The fixing step is one that fixes the visible image transferred to the recording medium using a fixing apparatus. The fixing step may be carried out using developer of each color transferred to the recording medium, or in one operation when the developers of each color have been laminated.

The fixing apparatus may be properly selected from heat and pressure units known in the art. Examples of heat and pressure unit include a combination of a heat roller and pressure roller, and a combination of a heat roller, pressure roller, and endless belt.

The heating temperature in the heat-pressure unit is preferably 80° C. to 200° C. Further, an optical fixing unit known in the art may be used in addition to or instead of the fixing step and fixing unit, depending on the application.

The charge-eliminating step is one that applies a discharge bias to the photoconductor to discharge it, which may be performed by a charge-eliminating unit.

The charge-eliminating unit may be properly selected from charge-eliminating units known as long as capable of applying a discharge bias to the photoconductor such as discharge lamps.

The cleaning step is one that removes electrophotographic toner remaining on the photoconductor, and may be performed by a cleaning unit.

The cleaning unit may be properly selected from cleaning units known in the art as long as capable of removing electrophotographic toner remaining on the photoconductor, and a magnetic brush cleaner, electrostatic brush cleaner, magnetic roller cleaner, blade cleaner, brush cleaner, and web cleaner are exemplified.

The recycling step is one that recycles the electrophotographic toner removed in the cleaning step into the developing step, and may be performed by use of the recycling unit. The recycling unit may be properly selected from transport units known in the art.

The controlling step is one that controls the respective processes, and may be carried out by use of the controlling unit.

The controlling unit may be properly selected depending on the application as long as capable of controlling the entire units; the controlling unit may be equipped with devices such as sequencers and computers.

The image forming processes and apparatuses according to the present invention will be explained with reference to figures. In the image forming processes and apparatuses, the photoconductor comprising the crosslinked layer is employed, and charging, exposing, and developing are carried out using the photoconductor, followed by transferring, fixing, and cleaning.

FIG. 3 is a schematic view illustrating an exemplary image forming apparatus. A charger 3 is used as a charging unit for evenly charging a photoconductor. Examples of the charging unit include a corotron device, scorotron device, solid discharging device, pin electrode device, roller charging device, conductive brush device and the like.

Specifically, the construction of the present invention is advantageous in charging units such as of contact charging type or non-contact close charging type where the photosensitive composition decomposes under close discharge. The contact charging type refers to a charging process carried out by directly contacting a charging roller, charging brush or charging blade to the photoconductor; the close charging type refers to a charging process, wherein a charging roller is located in non-contact state at distance of 200 μm or less from the surface of the photoconductor. When the distance is excessively long, the charging may be unstable, whereas when the distance is excessively short, the surface of the charging member may be stained by toner remaining on the photoconductor. Therefore, the distance is preferably in the range of 10 to 200 μm, more preferably is 10 to 100 μm.

The image forming unit 5 is employed for forming an electrostatic latent image on photoconductor 1 charged evenly. As for the light source, light emitters such as a fluorescent lamp, tungsten lamp, halogen lamp, mercury lamp, sodium lamp, light emitting diode (LED), semiconductor laser (LD), and electro luminescence may be employed. For providing light only at a desired spectral region, filters such as a sharply cutting filter, bandpass filter, near-infrared cutting filter, dichroic filter, interference filter, and conversion filter for color temperature may be employed.

The developing unit 6 is employed for visualizing the latent electrostatic image formed on the photoconductor 1. The developing may be of one-component developing, two-component developing using a dry toner, or wet developing using a wet toner. When a positive (negative) charge is applied to the photoconductor and image exposure is performed, a positive (negative) electrostatic latent image will be formed on the photoconductor surface. If the latent image is developed with a toner (charge detecting particles) of negative (positive) polarity, a positive image will be obtained, and a negative image will be obtained if the image is developed with a toner of positive (negative) polarity.

Further, transferring charger 10 is employed to transfer the visualized toner image from the photoconductor to transferring body 9. In order conduct the transferring properly, pre-transferring charger 7 may be utilized. In order to carry out the transferring, such processes or ways may be employed as electrostatic transferring using a transfer charger and a bias roller, mechanical transferring process such as adhesion transfer, pressure transfer and the like, and the magnetic transferring process. The charging unit may be employed for carrying out the electrostatic transferring process.

In order to separate transferring body 9 from the photoconductor 1, separation charger 11 or separation claw 12 may be utilized. Additionally, other separation means may be employed such as electrostatic adsorption-induction, stripping using a side belt, stripping by tip grip transportation, self stripping and the like. The separation charger 11 can be employed for the charging unit.

Fur brush 14 and/or cleaning blade 15 may be employed in order to remove the toner remaining on the photoconductor after the transferring. Further, in order to carry out the cleaning more effectively, pre-cleaning charger 13 may be employed. Other cleaning means include the wave process, magnet brush process and the like, which may be used alone or in combination.

A discharging unit may be employed in order to remove the latent image on the photoconductor, depending on the requirement. The discharging means may be discharging lamp 2 and a discharging charger, which may utilize the light source for light exposure and the charging unit, respectively, and also eraser 4 may be employed. Reference number 8 indicate a paper-feed roller.

In addition, processes for script reading, paper supplying, fixing, and paper releasing may be carried out conventionally.

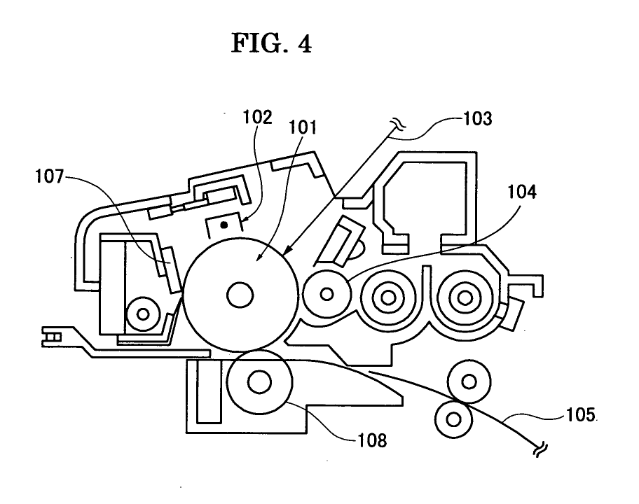

The photoconductors according to the present invention may be advantageously mounted to image forming apparatuses such as copiers, facsimiles, laser printers, and composite apparatuses. In an aspect, the photoconductors are attached to process cartridges and the process cartridges are mounted detachably to the image forming apparatuses, thereby providing users with conveniences of repeated and prolonged usages of photoconductors. FIG. 4 shows an exemplary process cartridge.

The process cartridge for image forming apparatuses comprises photoconductor 101, and at least one of charging unit 102, development unit 104, transferring unit 106, cleaning unit 107, and charging eliminating unit 108, and is detachably mounted to a main body of the image forming apparatuses.

With respect to the image forming process by use of the apparatus shown in FIG. 4, an electrostatic latent image is formed on photoconductor 101 through charging by means of charging unit 102 and exposing by means of light exposing unit 103, the electrostatic latent image is developed by means of developing unit 104 using a toner, the developed image is transferred and printed by means of transferring unit 106 on transfer material 105, while photoconductor 101 being rotated. Then, the surface of the photoconductor 101 is cleaned by cleaning unit 107 and also is charge-eliminated by means of charge-eliminating unit 108. These procedures are repeated and printings are provided repeatedly. In the present invention, in addition to the photoconductors according to the present invention, process cartridges are provided that comprise the photoconductor and at least one unit selected from the group consisting of charging unit, developing unit, transferring unit, cleaning unit, and discharging unit, thus the photoconductor and at least one unit are provided integrally.

As clearly seen from the above description, the photoconductors according to the present invention can be widely employed in copiers and also in various electrophotography fields such as laser beam printers, CRT printers, LED printers, liquid crystal printers, and laser engravings.

<Example of Synthesizing Compound Having One Functionality and Charge Transport Structure>

The compounds having one functionality and a charge transport structure adapted to the present invention may be synthesized, for example, by the process described in Japanese Patent No. 3164426. An example is as follows:

(1) Synthesis of Hydroxy Group-Substituted Triarylamine Compound of Formula B

To 240 ml of sulfolane, 113.85 grams (0.3 mol) of methoxy group-substituted triarylamine compound of Formula A and 138 grams (0.92 mol) of sodium iodide are added and heated to 60° C. while flowing nitrogen gas. In the solution, 99 grams (0.91 mol) of trimethylchlorosilane is dropwisely added for 1 hour and stirred at about 60° C. for 4.5 hours, and the reaction was completed. About 1500 ml of toluene was added to the reactant, then the reaction product was cooled to room temperature and repeatedly rinsed with water and an aqueous sodium carbonate solution.

Then, the solvent was removed from the solution and the residue was purified by means of a column chromatography (adsorption medium: silica gel, developing solvent: toluene/ethyl acetate=20/1). The resulting light yellow oil was crystallized with adding cyclohexane. Consequently, 88.1 grams of white crystal expressed by Formula B having a melting point of 64.0 to 66.0° C. was obtained in the yield of 80.4%.

TABLE 2

| Element analysis (%) | C | H | N |
|---|---|---|---|
| Measured | 85.06 | 6.41 | 3.73 |
| Calculated | 85.44 | 6.34 | 3.83 |

| | |
|---|---|
| 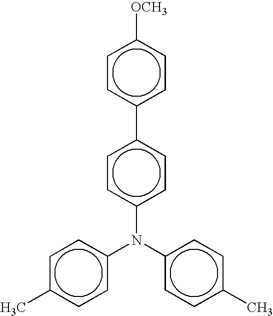 | Formula A |
| 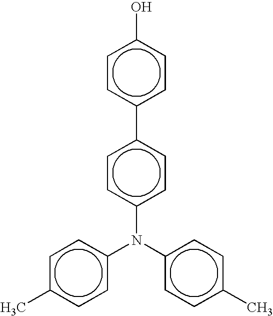 | Formula B |

(2) Triarylamino Group-Substituted Acrylate Compound (Compound No. 54)

The hydroxy group-substituted triarylamine compound expresses by Formula B of 82.9 grams (0.227 mol) obtained in above (1) was dissolved in 400 grams of tetrahydrofuran, and an aqueous sodium hydroxide solution, containing 12.4 grams of NaOH and 100 grams of water, was dropwisely added thereto. The resulting solution was cooled to 5° C. and 25.2 grams (0.272 mol) of acrylic acid chloride was added thereto over 40 minutes. Then, the reactant was stirred at 5° C. for 3 hours and the reaction was completed. The reaction product was poured into water and was extracted with toluene. The extract was repeatedly rinsed with an aqueous sodium bicarbonate solution and water. The solvent was removed from the solution and the residue was purified by means of a column chromatography (adsorption medium: silica gel, developing solvent: toluene). The resulting colorless oil was crystallized within n-hexane. Consequently, 80.73 grams of white crystal of the compound No. 54 having a melting point of 117.5 to 119.0° C. was obtained with the yield of 84.8%.

TABLE 3

| Element analysis | | | |
|---|---|---|---|
| (%) | C | H | N |
| Measured | 83.13 | 6.01 | 3.16 |
| Calculated | 83.02 | 6.00 | 3.33 |

The present invention will be illustrated in more detailed with reference to examples given below, but these are not to be construed as limiting the present invention. All percentages and parts are by mass unless indicated otherwise.

### EXAMPLE 1

On an aluminum cylinder of 30 mm in diameter, the coating liquid for undercoat layer, the coating liquid for charge generating layer, and the coating liquid for charge transport layer, each having the composition described below, were sequentially applied and dried to form an undercoat layer of 3.5 μm thick, a charge generating layer of 0.2 μm thick, and a charge transport layer of 18 μm thick.

Then, the coating liquid for crosslinked layer having the following composition was coated over the charge transport layer by spray coating, and the coating was subjected to optical irradiation using a metal halide lamp of 160 W/cm under the conditions of 120 mm from the light source, 500 mW/cm² of irradiation energy, and 30 seconds of irradiating period, and then was subjected to heating at 130° C. for 20 minutes, thereby yielded a crosslinked layer of 4 μm thick and the inventive photoconductor was obtained.

[Coating Liquid for Undercoat Layer]

| | |
|---|---|
| Alkyde resin | 6 parts |
| (Beckosol 1307-60-EL, by Dainippon Ink and Chemicals, Inc.) | |
| Melamine resin | 4 parts |
| (Super Bekamine G-821-60, by Dainippon Ink and Chemicals, | |
| Inc.) | |
| Titanium oxide | 40 parts |
| Methylethylketone | 50 parts |

[Coating Liquid for Charge Generating Layer]

| | | |
|---|---|---|
| Bisazo pigment of Formula (I) below | 2.5 | parts |
| Polyvinylbutyral (XYHL, by Union Carbide Co.) | 0.5 | part |
| Cyclohexanone | 200 | parts |
| Methylethylketone | 80 | parts |

| | |
|---|---|
| 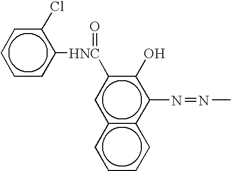 | Formula (I) |

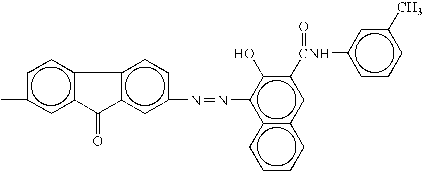

[Coating Liquid for Charge Transport Layer]

| | | |
|---|---|---|
| Bisphenol Z polycarbonate | 10 | parts |
| (Panlite TS-2050, by Teijin Chemicals Ltd.) | | |
| Charge transport substance of formula (II) below | 7 | parts |
| (compound having a lower molecular mass) | | |
| Tetrahydrofuran | 100 | parts |
| 1% solution of silicone oil in tetrahydrofuran | 0.2 | part |
| (KF50-100CS, by Shin-Etsu Chemical Co.) | | |

| | |
|---|---|
| 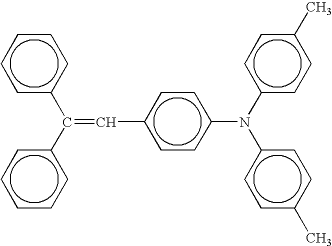 | Formula (II) |

[Coating Liquid for Crosslinked Layer]

| | |
|---|---|
| Radical polymerizable monomer having three or more | 10 parts |
| functionalities and no charge transport structure | |
| Trimethylolpropane triacrylate (KAYARAD TMPTA, | 10 parts |
| by Nippon Kayaku Co.), molecular mass: 296, number | |
| of functional group: three, molecular mass/number | |
| of functional group = 99 Radical polymerizable | |
| compound having one functionality and a charge | |
| transport structure (exemplified compound No. 54) | |
| Photopolymerization initiator | 2 parts |
| 1-hydroxy-cyclohexyl-phenyl-ketone | |
| (IRGACURE 184, by Ciba Specialty Chemicals) | |
| Thermal polymerization initiator | 2 parts |
| 2,2-bis(4,4-di-t-butylperoxycyclohexyl)propane | |
| (Perakdox 12-EB20, Kayaku Akzo Corporation) | |
| Tetrahydrofuran | 100 parts |

### EXAMPLE 2

A photoconductor was produced in the same manner as Example 1, except that the radical polymerizable monomer having three or more functionalities and no charge transport structure in Example 1 was changed into the monomer described below.

| | |
|---|---|
| Radical polymerizable monomer having three or more | 10 parts |
| functionalities and no charge transport structure | |
| Dimethylolpropane tetraacrylate (SR-355, by Kayaku Sartomer | |
| Co.), molecular mass: 466, number of functional group: four, | |
| molecular mass/number of functional group = 117 | |

### EXAMPLE 3

A photoconductor was produced in the same manner as Example 1, except that the radical polymerizable monomer having three or more functionalities and no charge transport structure, the photopolymerization initiator, and the thermal polymerization initiator in Example 1 were changed into those described below.

| | |
|---|---|
| Radical polymerizable monomer having three or more | 10 parts |
| functionalities and no charge transport structure | |
| Pentaerythritol tetraacrylate (SR-295, by Kayaku Sartomer Co.) | |
| molecular mass: 352, number of functional group: four, | |
| molecular mass/number of functional group = 88 | |
| Photopolymerization initiator | 2 parts |
| 2,2-dimethoxy-1,2-diphenylethane-1-one | |
| (IRGACURE 651, by Ciba Specialty Chemicals Co.) | |
| Thermal polymerization initiator | 2 parts |
| t-butyl-peroxy-2-ethylhexanoate (Kayaester O, by Kayaku Akzo | |
| Co.) | |

### EXAMPLE 4>

A photoconductor was produced in the same manner as Example 1, except that the radical polymerizable monomer having three or more functionalities was changed into two species of monomers described below.

| | |
|---|---|
| Radical polymerizable monomer having three or more | 5 parts |
| functionalities and no charge transport structure | |
| Dipentaerythritol hexaacrylate | |
| (KAYARAD DPHA, by Nippon Kayaku Co.) | |
| molecular mass: 536, number of functional group: 5.5, | |
| molecular mass/number of functional group = 97 | |
| Radical polymerizable monomer having three or more | 5 parts |
| functionalities and no charge transport structure | |
| Caprolactone-modified dipentaerythritol hexaacrylate | |
| (KAYARAD DPCA-60, by Nippon Kayaku Co.) | |
| molecular mass: 1263, number of functional group: six, | |
| molecular mass/number of functional group = 211 | |

### EXAMPLE 5

A photoconductor was produced in the same manner as Example 1, except that the radical polymerizable monomer having three or more functionalities and no charge transport structure in Example 1 was changed into the monomer described below.

| | |
|---|---|
| Radical polymerizable monomer having three or more | 10 parts |
| functionalities and no charge transport structure | |
| Caprolactone-modified dipentaerythritol hexaacrylate | |
| (KAYARAD DPCA-60, by Nippon Kayaku Co.) | |
| molecular mass: 1263, number of functional group: six, | |
| molecular mass/number of functional group = 211 | |

### EXAMPLE 6

A photoconductor was produced in the same manner as Example 1, except that the radical polymerizable monomer having three or more functionalities and no charge transport structure in Example 1 was changed into the monomer described below.

| | |
|---|---|
| Radical polymerizable monomer having three or more | 10 parts |
| functionalities and no charge transport structure | |
| Caprolactone-modified dipentaerythritol hexaacrylate | |
| (KAYARAD DPCA-120, by Nippon Kayaku Co.) | |
| molecular mass: 1947, number of functional group: six, | |
| molecular mass/number of functional group = 325 | |

### EXAMPLE 7

A photoconductor was produced in the same manner as Example 1, except that the radical polymerizable monomer having three or more functionalities was changed into two species of monomers described below.

| | |
|---|---|
| Radical polymerizable monomer having three or more | 5 parts |
| functionalities and no charge transport structure | |
| Dipentaerythritol hexaacrylate | |
| (KAYARAD DPHA, by Nippon Kayaku Co.) | |
| molecular mass: 536, number of functional group: 5.5, | |
| molecular mass/number of functional group = 97 | |
| Radical polymerizable monomer having three or more | 5 parts |
| functionalities and no charge transport structure | |
| PO-modified glycerol triacrylate | |
| (KAYARAD FM-280, by Nippon Kayaku Co.) | |
| molecular mass: 463, number of functional group: three, | |
| molecular mass/number of functional group = 154 | |

### EXAMPLE 8

A photoconductor was produced in the same manner as Example 1, except that the radical polymerizable compound having one functionality and a charge transport structure in Example 1 was changed into 10 parts of Exemplified Compound No. 127.

### EXAMPLE 9

A photoconductor was produced in the same manner as Example 1, except that the radical polymerizable monomer having three or more functionalities in Example 1 was changed into the monomer described below, and the radical polymerizable compound having one functionality in Example 1 was changed into 10 parts of Exemplified Compound No. 138.

| | |
|---|---|
| Radical polymerizable monomer having three or more | 10 parts |
| functionalities and no charge transport structure | |
| Dipentaerythritol hexaacrylate | |
| (KAYARAD DPHA, by Nippon Kayaku Co.) | |
| molecular mass: 536, number of functional group: 5.5, | |
| molecular mass/number of functional group = 97 | |

### EXAMPLE 10

A photoconductor was produced in the same manner as Example 1, except that the radical polymerizable compound having one functionality in Example 1 was changed into 10 parts of Exemplified Compound No. 94.

### EXAMPLE 11

A photoconductor was produced in the same manner as Example 10, except that the radical polymerizable compound having one functionality in Example 10 was changed into 10 parts of Exemplified Compound No. 138.

### EXAMPLE 12

A photoconductor was produced in the same manner as Example 1, except that the amount of the radical polymerizable monomer having three or more functionalities in Example 1 was changed into 6 parts, and the amount of the radical polymerizable compound having one functionality in Example 1 was changed into 14 parts.

### EXAMPLE 13

A photoconductor was produced in the same manner as Example 1, except that the amount of the radical polymerizable monomer having three or more functionalities in Example 1 was changed into 14 parts, and the amount of the radical polymerizable compound having one functionality in Example 1 was changed into 6 parts.

### EXAMPLE 14

A photoconductor was produced in the same manner as Example 1, except that the charge transport material incorporated into the coating liquid for the charge transport layer in Example 1 was changed into the charge transport substance described below, and the resulting coating liquid was coated and dried on the charge generating layer to form a charge transport layer of 18 μm thick, then a crosslinked layer was provided on the charge transport layer in the same manner as Example 1, thereby to produce the photoconductor.

[Coating Liquid for Charge Transport Layer]

| | | |
|---|---|---|
| Charge transport polymer shown below | 15 | parts |

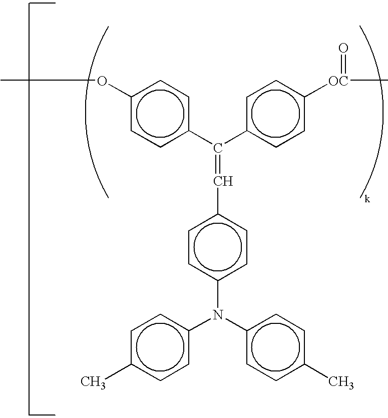

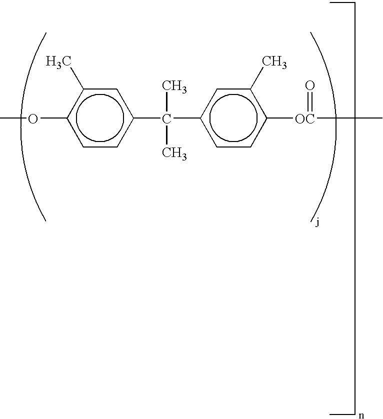

k = 042, j = 0.58 Mw = 160000 (polystyrene conversion)

| | | |
|---|---|---|
| Tetrahydrofuran | 100 | parts |
| 1% solution of silicone oil in tetrahydrofuran | 0.3 | part |
| (KF50-100CS, by Shin-Etsu Chemical Co.) | | |

### EXAMPLE 15>

A photoconductor according to the present invention was produced in the same manner as Example 1, except that the coating liquid for crosslinked layer, containing the ingredients shown below, was sprayed onto the charge generating layer equivalent to that of Example 1, and the coating was subjected to optical irradiation for 40 seconds to form a crosslinked layer of 22 μm thick.

[Coating Liquid for Crosslinked Layer]

| | |
|---|---|
| Radical polymerizable monomer having three or more | 10 parts |
| functionalities and no charge transport structure | |
| Caprolactone-modified dipentaerythritol hexaacrylate | |
| (KAYARAD DPCA-60, by Nippon Kayaku Co.) | |
| molecular mass: 1263, number of functional group: six, | |
| molecular mass/number of functional group = 211 | |
| Radical polymerizable compound having one functionality | 10 parts |
| (exemplified compound No. 54) | |
| Photopolymerization initiator | 2 parts |
| 1-hydroxy-cyclohexyl-phenyl-ketone | |
| (IRGACURE 184, by Ciba Specialty Chemicals Co.) | |
| Thermal polymerization initiator | 2 parts |
| t-butyl-peroxy-2-ethylhexanoate (Kayaester O, by Kayaku | |
| Akzo Co.) | |
| Tetrahydrofuran | 60 parts |
| Cyclohexane | 20 parts |
| 1% solution of silicone oil in tetrahydrofuran | 0.2 part |
| (KF50-100CS, by Shin-Etsu Chemical Co.) | |

### COMPARATIVE EXAMPLE 1

A photoconductor was produced in the same manner as Example 1, except that the thermal polymerization initiator was not incorporated into the coating liquid for crosslinked layer, and the coating was not subjected to heating.

### COMPARATIVE EXAMPLE 2

A photoconductor was produced in the same manner as Example 1, except that the photopolymerization initiator was not incorporated into the coating liquid for crosslinked layer, and the coating was not subjected to optical irradiation.

### COMPARATIVE EXAMPLE 3

A photoconductor was produced in the same manner as Example 1, except that the radical polymerizable monomer having three or more functionalities in Example 1 was changed into 10 parts of the radical polymerizable monomer having two functionalities shown below.

| | |
|---|---|
| Radical polymerizable monomer having two functionalities and | 10 parts |
| no charge transport structure | |
| 1,6-hexanediol diacrylate (by Wako Pure Chemical, Ltd.) | |
| Molecular mass: 226, Number of functional group: two, | |
| Molecular mass/number of functional group = 113 | |

### COMPARATIVE EXAMPLE 4

A photoconductor was produced in the same manner as Example 1, except that the coating liquid for crosslinked layer contained no radical polymerizable monomer having three or more functionalities, and the amount of the radical polymerizable compound having one functionality in Example 1 was changed into 20 parts.

### COMPARATIVE EXAMPLE 5

A photoconductor was produced in the same manner as Example 1, except that the coating liquid for crosslinked layer contained no radical polymerizable compound having one functionality, and the amount of the radical polymerizable monomer having three or more functionalities in Example 1 was changed into 20 parts.

### COMPARATIVE EXAMPLE 6

A photoconductor was produced in the same manner as Example 1, except that the coating liquid for crosslinked layer contained no radical polymerizable compound having one functionality, instead contained 10 parts of the charge transport substance of lower molecular mass expressed by Formula (II) described above.

### COMPARATIVE EXAMPLE 7

A photoconductor was produced in the same manner as Example 1, except that the radical polymerizable compound having one functionality was changed into 10 parts of the radical polymerizable compound having two functionalities shown below.

| | |
|---|---|
| Radical polymerizable compound having two functionalities and | 10 parts |
| charge transport structure | |
| 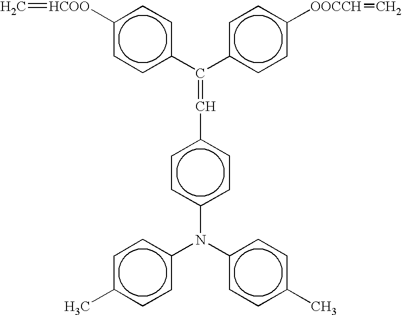 | |

### COMPARATIVE EXAMPLE 8

A photoconductor was produced in the same manner as Example 1, except that the crosslinked layer in Example 1 was not provided, and the thickness of the charge transport layer was changed into 22 μm.

Evaluation of Photoconductors

Photoconductors of Example 1 to 15 and Comparative Examples 1 to 8 were evaluated in terms of printing test using 40,000 sheets of A4 size paper. Each of the respective photoconductors was attached to an electrophotographic process cartridge, and the process cartridge was mounted to modified Imagio Neo 270 copier (by Ricoh Company, Ltd) equipped with a semiconductor laser of 655 nm wavelength as the light source. The initial voltage at dark space was adjusted to −700 volts. Then, the test was started; voltages at dark space and exposed space were measured at starting and after printing of 40,000 sheets, and decreases of thickness due to wear were determined. When resulting images were remarkably inferior, the test was stopped on the way. The results were summarized in Table 4.

TABLE 4

| | | | | | Potential after | |
|---|---|---|---|---|---|---|
| | | Depth | Initial | | Printing 40000 | |
| | Surface | of | Potential (volt) | | Sheets | |
| | Roughness | Wear | dark | irradiated | dark | irradiated |
| | (μm) | (μm) | site | site | site | site |
| Ex. 1 | 0.23 | 0.8 | 700 | 40 | 710 | 60 |
| Ex. 2 | 0.18 | 0.9 | 700 | 40 | 700 | 65 |
| Ex. 3 | 0.25 | 0.7 | 700 | 40 | 700 | 70 |
| Ex. 4 | 0.31 | 0.8 | 700 | 40 | 720 | 65 |
| Ex. 5 | 0.38 | 1.3 | 700 | 40 | 690 | 55 |
| Ex. 6 | 0.26 | 2.2 | 700 | 35 | 680 | 55 |
| Ex. 7 | 0.32 | 1.2 | 700 | 40 | 710 | 70 |
| Ex. 8 | 0.33 | 0.8 | 700 | 50 | 710 | 70 |
| Ex. 9 | 0.28 | 1.2 | 700 | 50 | 720 | 75 |
| Ex. 10 | 0.27 | 1.0 | 700 | 50 | 710 | 75 |
| Ex. 11 | 0.33 | 1.2 | 700 | 50 | 720 | 75 |
| Ex. 12 | 0.35 | 2.4 | 700 | 30 | 670 | 45 |
| Ex. 13 | 0.29 | 0.4 | 700 | 55 | 720 | 135 |
| Ex. 14 | 0.19 | 0.5 | 700 | 45 | 710 | 75 |
| Ex. 15 | 0.40 | 1.7 | 700 | 60 | 710 | 150 |
| Comp. Ex. 1 | 0.38 | 1.2 | 700 | 40 | 710 | 60 |
| Comp. Ex. 2 | 0.30 | 2.8 | 700 | 40 | 670 | 50 |
| Comp. Ex. 3 | 0.31 | 5.0 | 700 | 40 | 670 | 110 |
| Comp. Ex. 4 | 2.52 | — | 700 | 60 | — | — |
| Comp. Ex. 5 | 0.40 | — | 700 | 160 | — | — |
| Comp. Ex. 6 | 1.76 | — | 700 | 50 | — | — |
| Comp. Ex. 7 | 1.91 | 4.0 | 700 | 50 | 670 | 110 |
| Comp. Ex. 8 | <0.1 | 4.8 | 700 | 30 | 600 | 45 |

The results shown in Table 4 and visual inspection on images demonstrated as follows. In Examples 1 to 5, 8 to 11, and 14, the images were clear at initial printing and also at around 40000 th printing. In Examples 6, 7, 12, 13, and 15, the images were clear at initial printing; however, background smear, decrease of image density, and/or streak were slightly observed in partial sheets at around 40000 th printing. The results of wear and electrical potential did not apparently represent significant problems in all of Examples 1 to 15.

In Comparative Example 1, the images were clear at initial printing and also at around 40000 th printing, however, the wear was significant; in Comparative Example 2, background smear was observed at around 40000 th printing, and the wear was significant; in Comparative Example 3, remarkable background smear was observed at around 40000 th printing; in Comparative Example 4, remarkable streak generated at initial printing, therefore, the test was stopped on the way; in Comparative Example 5, image density remarkably decreased due to potential increase on irradiated sites at around 5000 th printing, therefore, the test was stopped on the way; in Comparative Example 6, image density was remarkably nonuniform due to nonuniform coating, therefore, the test was stopped on the way; in Comparative Example 7, remarkable streak generated at around 40000 th printing possibly due to small irregularities derived from volume shrinkage at preparing the coating; in Comparative Example 8, remarkable background smear was observed at around 40000 th printing.

In addition, from the results shown in Table 4, it is considered that higher surface roughness of crosslinked layer such as Comparative Example 4, 6, and 7 results in inferior images; formulation of crosslinked layer other than the present invention results in nonuniform surface, lower wear resistance, and/or inferior electric properties, which leads to lower durability; photoconductors without a crosslinked layer bring about lower wear resistance and poor durability such as Comparative Example 8.

### EXAMPLE 16

A photoconductor was prepared in the same manner as Example 1 and subjected to a continuous 2000 sheets copying of A4 crosswise chart with an image area of 1%, using Imagio MF200 copier (recording LD wave length: 655 nm, AC overlapped charge: amplitude 2 kV, frequency: 1 kHz, DC voltage: −750 V, by Ricoh Company, Ltd) under a condition of temperature 22° C. and humidity 55%. Then, the photoconductor and the copier were transferred to a condition of temperature 30° C. and relative humidity 90% and subjected to a copying process. The resulting image was compared with the initial image. As a result, it was possible to obtain an image having a resolution substantially equal to the initial image, without character thickening.

### COMPARATIVE EXAMPLE 9

A photoconductor was prepared in the same manner as Comparative Example 1 and tested following the procedures of Example 16 to compare the image at temperature 30° C. and humidity 90% with the initial image. As a result, the image at temperature 30° C. and humidity 90% showed remarkable resolution drop and significant reduction in half tone image density, as compared to the initial image.

As compared to the photoconductor of Comparative Example 9 having considerable irregularity on the cross-linked surface, the photoconductor having the crosslinked layer of Example 16 according to the present invention could maintain the crosslinked surface at high level of resistance by way of eliminating oxidizing gas generated from the charging unit and deteriorated substances on the photoconductor, thereby capable of stably providing high quality images even in high humidity circumstance. On the contrary, the resistance was lowered and image flow was induced under high humidity circumstance, the reason is considered that uncrosslinked —CH═CH₂ exists in the crosslinked layer and acidic gas absorbs at the sites.

As explained above, it is demonstrated that since the outermost surface layer of the photosensitive layer in the present invention comprises a crosslinked layer formed by applying a coating solution containing a radical polymerizable monomer having three or more functionalities and no charge transport structure and a radical polymerizable compound having one functionality and a charge transport structure, followed by curing through photopolymerization and thermal polymerization, it is possible to provide photoconductors with prolonged lifetime and high performance capable of maintaining superior images for long period without being significantly affected by circumstance conditions. Also, it is demonstrated that the image forming process, the image forming apparatus and the process cartridge for image forming apparatuses using the photoconductor according to the present invention may provide superior performance and high reliability.

1. A photoconductor, comprising:
a support, and
a photosensitive layer disposed on the support,
wherein the photosensitive layer comprises a crosslinked layer,
the crosslinked layer comprises a radical polymerizable monomer having three or more functionalities and no charge transport structure and a radical polymerizable compound having one functionality and a charge transport structure, and
the crosslinked layer is cured by way of photopolymerization and thermal polymerization.

2. The photoconductor according to claim 1, wherein the crosslinked layer comprises a photopolymerization initiator and a thermal polymerization initiator.

3. The photoconductor according to claim 1, wherein the functional group of the radical polymerizable monomer having three or more functionalities is one of acryloyloxy group and methacryloyloxy group.

4. The photoconductor according to claim 1, wherein the radical polymerizable monomer having three or more functionalities has a ratio of molecular mass to functionalities of 250 or less.

5. The photoconductor according to claim 1, wherein the functional group of the radical polymerizable compound having one functionality is one of acryloyloxy group and methacryloyloxy group.

6. The photoconductor according to claim 1, wherein the charge transport structure of the radical polymerizable compound having one functionality contains a triarylamine structure.

7. The photoconductor according to claim 1, wherein the radical polymerizable compound having one functionality is selected from the compounds expressed by General Formulas (1) and (2): 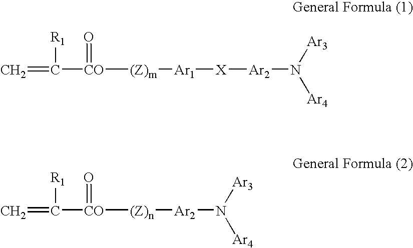
wherein R₁ represents a hydrogen atom, halogen atom, alkyl group which may be substituted, aralkyl group which may be substituted, aryl group which may be substituted, cyano group, nitro group, alkoxy group, —COOR₇ (R₇ represents a hydrogen atom, alkyl group which may be substituted, aralkyl group which may be substituted, or aryl group which may be substituted), halogenated carbonyl group, or CONR₈R₉ (R₈ and R₉ each represents a hydrogen atom, halogen atom, alkyl group which may be substituted, aralkyl group which may be substituted, or aryl group which may be substituted, R₈ and R₉ may be identical or different); Ar₁ and Ar₂ each represents a substituted or unsubstituted arylene group, which may be identical or different; Ar₃ and Ar₄ each represents a substituted or unsubstituted aryl group, which may be identical or different; X represents a single bond, substituted or unsubstituted alkylene group, substituted or unsubstituted cycloalkylene group, substituted or unsubstituted alkylene ether group, oxygen atom, sulfur atom, or vinylene group; Z represents a substituted or unsubstituted alkylene group, substituted or unsubstituted alkylene ether group, or alkyleneoxycarbonyl group; “m” and “n” each represents an integer of 0 to 3.

8. The photoconductor according to claim 1, wherein the radical polymerizable compound having one functionality is selected from the compounds expressed by the General Formula (3): 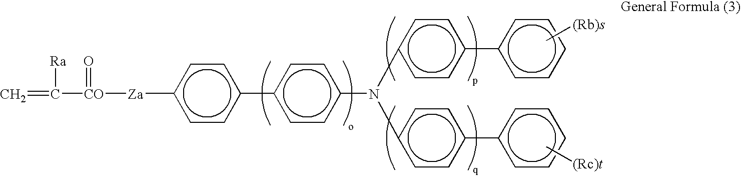
wherein “o,” “p”, and “q” each represents an integer of 0 or 1; Ra represents a hydrogen atom, methyl group; Rb and Rc each represents a substituent other than a hydrogen atom which is a C₁₋₆ alkyl group and may be different when they are two or more; “s” and “t” each represents an integer of 0 to 3; Za represents a single bond, methylene group, ethylene group, or group expressed by the following formulas:

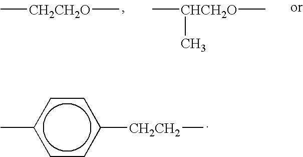

9. The photoconductor according to claim 1, wherein the content of the radical polymerizable monomer having three or more functionalities is 20% by mass to 80% by mass based on the total mass of the crosslinked layer.

10. The photoconductor according to claim 1, wherein the content of the radical polymerizable compound having one functionality is 20% by mass to 80% by mass based on the total mass of the crosslinked layer.

11. The photoconductor according to claim 1, wherein the photosensitive layer represents a laminated structure comprising the support, a charge generating layer, and a charge transport layer in this order, and the crosslinked layer is the surface layer of the photosensitive layer.

12. The photoconductor according to claim 11, wherein the underlayer of the charge transport layer in the photosensitive layer comprises a charge transport polymer.

13. The photoconductor according to claim 12, wherein the charge transport polymer is a polycarbonate that contains a triarylamine structure at one of main chains and side chains thereof.

14. An image forming process comprising:
forming an electrostatic latent image on a photoconductor, developing the electrostatic latent image by means of a toner to form a visible image, transferring the visible image on a recording medium, and fixing the transferred image on the recording medium,
wherein the photoconductor comprises a support, and a photosensitive layer disposed on the support,
the photosensitive layer comprises a crosslinked layer,
the crosslinked layer comprises a radical polymerizable monomer having three or more functionalities and no charge transport structure and a radical polymerizable compound having one functionality and a charge transport structure, and
the crosslinked layer is cured by way of photopolymerization and thermal polymerization.

15. An image forming apparatus comprising a photoconductor, an electrostatic latent image forming unit configured to form an electrostatic latent image on the photoconductor, a developing unit configured to develop the electrostatic latent image by means of a toner to form a visible image, a transferring unit configured to transfer the visible image on a recording medium, and a fixing unit configured to fix the transferred image on the recording medium,
wherein the photoconductor comprises a support, and a photosensitive layer disposed on the support, the photosensitive layer comprises a crosslinked layer,
the crosslinked layer comprises a radical polymerizable monomer having three or more functionalities and no charge transport structure and a radical polymerizable compound having one functionality and a charge transport structure, and
the crosslinked layer is cured by way of photopolymerization and thermal polymerization.

16. The image forming apparatus according to claim 15, wherein the functional group of the radical polymerizable monomer having three or more functionalities is one of acryloyloxy group and methacryloyloxy group.

17. The image forming apparatus according to claim 15, wherein the radical polymerizable monomer having three or more functionalities has a ratio of molecular mass to functionalities of 250 or less.

18. The image forming apparatus according to claim 15, wherein the functional group of the radical polymerizable compound having one functionality is one of acryloyloxy group and methacryloyloxy group.

19. The image forming apparatus according to claim 15, wherein the charge transport structure of the radical polymerizable compound having one functionality contains a triarylamine structure.

20. A process cartridge comprising a photoconductor, and at least one unit selected from the group consisting of charging unit, developing unit, transferring unit, cleaning unit, and discharging unit,
wherein the process cartridge is mounted detachably to an image forming apparatus, the photoconductor comprises a support, and a photosensitive layer disposed on the support, the photosensitive layer comprises a crosslinked layer,
the crosslinked layer comprises a radical polymerizable monomer having three or more functionalities and no charge transport structure and a radical polymerizable compound having one functionality and a charge transport structure, and
the crosslinked layer is cured by way of photopolymerization and thermal polymerization.
